(19) United States
(12) Patent Application Publication
(10) Pub. No.: US 2017/0103678 A1
(43) Pub. Date: Apr. 13, 2017

(54) SIMULATOR PROVIDING EDUCATION AND TRAINING

(71) Applicant: Project MCS, Inc., San Francisco, CA (US)

(72) Inventors: Kurt Gingher, San Francisco, CA (US); Andrew L. Dale, Berkeley, CA (US); Neil E. Seitz, St. Louis, MO (US); Michelle M. Katics, San Francisco, CA (US)

(21) Appl. No.: 15/277,701

(22) Filed: Sep. 27, 2016

Related U.S. Application Data
(60) Provisional application No. 62/240,688, filed on Oct. 13, 2015.

(51) Int. Cl. G09B 19/18; G06F 7/58; G09B 5/12; G06F 17/50

(52) U.S. Cl. CPC G09B 19/18; G06F 17/5009; G06F 7/588; G09B 5/12

(57) ABSTRACT

A simulator and corresponding method suitable for training and educating is provided. Specifically, the present invention relates to simulating performance of a portfolio in a manner that improves training and educational advancement of a user operating the simulator relative to other traditional training and educational tools. In particular, the present invention provides a new and different process that substantially reduces the amount of time required for a user to become educated and trained in an experiential manner as to how their choices will affect outcomes that traditionally require years to unfold.

### CROSS-REFERENCE TO RELATED APPLICATION(S)

This application claims priority to, and the benefit of co-pending U.S. Provisional Application No. 62/240,688, filed Oct. 13, 2015, for all subject matter common to both applications. The disclosure of said provisional application is hereby incorporated by reference in its entirety.

### FIELD OF THE INVENTION

The present invention relates to a simulator and corresponding method of operation suitable for training and educating. In particular, the present invention relates to simulating performance of a portfolio in a manner that improves training and educational advancement of a user operating the simulator relative to other traditional training and educational tools, dramatically decreasing the amount of time an individual needs to gain experience in a learn by doing model.

### BACKGROUND

The education and training of professionals currently happens over a lengthy time period, and typically referred to as having “experience”. It takes years to become experienced in many professional fields, including the field of lending, because after underwriting a loan or making a portfolio management decision, the lender typically must wait 6 to 24 months to observe the outcome, or impact of that decision. It takes many years for lenders to learn the intricacies of consumer lending portfolios, because it takes years for initial analysis to be performed, credits or loans issued, and then the payments by the borrowers to either occur on schedule, or not. Many institutions lend money to private individuals. Money is lent in the form of unsecured loans, such as credit cards or in the form of secured loans, such as mortgages and car loans. Retail banks make many of these loans but large retail chains and specialty lenders (car financers) also offer retail credit.

Some industries have developed simulators and analytics in an attempt to bridge the gap between levels of experience. One form of conventional simulator in the lending space is referred to as an analytical simulator. Analytical simulations take the historical data from existing lending portfolios and analyze them to identify trends in customer behavior. Based on the derived trends, these simulators extrapolate the trend lines into the future to predict what might happen under different situations. This type of simulation is generally used by risk managers in the course of performing their work, such as portfolio stress testing. These simulations are not typically appropriate in an educational setting because they do not smooth out and exaggerate trends and phenomena to ensure particular learning objectives. Instead, analytical simulations provide users with a prediction of what is likely to occur given a particular set of variables without requiring the user to make any determinations themselves. Furthermore, these predictions are primarily focused on looking back at historical data to decipher and identify variables, patterns, or combinations of variables that have the greatest impact on certain performance criteria; they are not structured in a look forward manner, and they do not provide the ability to influence and construct simulations with intentionally selected and manipulated key variables.

Another form of conventional simulator in the lending space is referred to as a scripted simulator. Scripted simulations are generally used in a purely educational setting. They present a set of scenarios and hypothetical situations and ask a user, a student, trainee, etc. “what would you do?”. Based on the user selecting one of a limited number of options the simulated portfolio is advanced along a flow diagram like script. The scripted simulators are very limited in usefulness because, by their very nature, they cannot support much complexity in the underlying model. At most there may be 10's or maybe 100's of possible combinations of input options across an entire simulation. The underlying algorithm is a decision tree (“if A, then B”), in contrast to a numerical set of user interface logic. As such, following the same starting scenario with exactly the same management decisions during a simulation results in the same outcome on the scripted decision tree of these simulators. Additionally, scripted simulations often are fixed such that there is limited replay-ability of the scripted scenarios by the user (e.g., the user may know the correct answer through memorization of the scenario, not through understanding of why that is the correct answer in that scenario). Furthermore, providing new scenarios to test a user's knowledge requires writing an entirely new script.

From the first steps of deciding what loans an institution wants to make to the final steps of collecting or writing-off past due loans, lending portfolio managers make many tough decisions and analyze large datasets in order to make those decisions. To achieve a desired level of education, training, and experience in this complex process can take years using conventional means.

### SUMMARY

There is a need for improved training and simulations alternatives for on-the-job training. The present invention is directed toward further solutions to address this need, in addition to having other desirable characteristics. Specifically, the present invention provides a new and different process that substantially reduces the amount of time required for a user to become educated and trained in an experiential manner (i.e., to learn from doing) as to how their choices will affect outcomes that traditionally require years to unfold, (for example, the outcomes within a lending portfolio and the customer). The conventional process of gaining experience in the field of lending can be reduced from years to hours or days using the system and method of the educational simulator of the present invention.

More specifically, the present invention is used for the acceleration of learning how to perform processes, such as manage retail credit portfolios. Additionally, the present invention also provides a new and innovative mechanism for simulating the performance of a retail credit portfolio by, e.g., exaggerating and manipulating key variables in a simulation. The new portfolio simulation mechanism is specifically designed to enhance and focus the educational experience.

In accordance with an embodiment of the present invention, a simulator system is provided. The simulator system includes a player engagement tool. The player engagement tool includes a user interface logic that provides a training simulation to a player on a client machine and receives one or more management decisions from the player during the training simulation. The player engagement tool also includes a portfolio simulator data that executes the training simulation and training material associated with the training simulation to be provided to the player. The training material is context specific information pertinent to management decisions the player is making during the training simulation with the user interface logic. The portfolio simulator updates the training simulation based on the one or more management decisions received by the user logic interface. The player engagement tool interacts with the player to provide the training simulation to the client machine of the player.

In accordance with aspects of the present invention, the user interface logic responds to a request from the client machine for the training simulation. Providing the training simulation can include rendering a training home page to the player on the client machine. The training material can explain an underlying phenomena of customer and portfolio behavior to assist the player in understanding a range and an effect of the one or more management decisions. The user interface logic can validate an input provided within the one or more management decisions, the validating including determining whether the one or more management decisions provided by the player match expected responses for the provided training simulation options.

In accordance with aspects of the present invention, the portfolio simulator provides feedback and reports to the player for use during the training simulation including prior to the player submitting one or more management decisions and after receiving the one or more management decisions from the player. The portfolio simulator can evaluate the one or more decisions from the player to determine whether the one or more decisions are technically possible but out-of-policy. The portfolio simulator can provide reports and tabular data to the player that reflect an impact the one or more management decisions had on the training simulation.

In accordance with aspects of the present invention, the player engagement tool further includes a digital coach configured to provide educational material to the player based on management decisions received from the player. The educational material can provide information to teach the player lessons to improve upon the one or more management decisions.

In accordance with an embodiment of the present invention, a simulator system is provided. The simulator system includes a portfolio simulator employing a stylized statistical simulation. The stylized statistical simulation includes a macroeconomic data tool that provides a selection of a baseline sensitivity curve, the baseline sensitivity curve representative of a stylized trend including key variables. The stylized statistical simulation also includes a calculation engine that generates a plurality of simulation accounts. The stylized statistical simulation further includes an account simulator that generates data for populating the plurality of simulation accounts using a random number generator. The calculation engine creates the stylized statistical simulation by creating a simulated reality using the plurality of simulation accounts that highlight and exaggerate key variables of the stylized trend, the key variables being limited to a predetermined standard deviation from a historical norm. The portfolio simulator provides the simplified and stylized statistical simulation to a player.

In accordance with aspects of the present invention, the portfolio simulator can be a state machine. The state machine can be maintained based upon the impact of one or more management decisions received from the player to a previous state of the state machine. The portfolio simulator can provide the simplified and stylized statistical simulation to a player including user inputs for one or more data management decisions. The portfolio simulator can receive the one or more data management decisions from the player and update the simplified and stylized statistical simulation based on the one or more data management decisions.

In accordance with aspects of the present invention, the portfolio simulator can receive a simulation call from a user interface logic for a selected training module. In response to receiving the simulation call, the portfolio simulator can provide the simplified and stylized statistical simulation for the selected training module.

In accordance with an embodiment of the present invention, a simulator method is provided. The method includes a portfolio simulator providing a plurality of training scenarios to a user. The method also includes a player engagement tool receiving management decisions from the user in response to the plurality of training scenarios. A discovery learning mode determines a result of the received management decisions. When determining the result is an incorrect management decision, the discovery learning mode identifies a strategy of the user causing the incorrect management decision and determines a corrective action, the corrective action comprising a context-specific hint. A digital coach provides the context-specific hint to the user. The player engagement tool receives new management decisions from the user and the user is provided with additional context-specific hints without providing a correct management decisions until the user submits the correct management decisions.

In accordance with aspects of the present invention, the portfolio simulator can receive a simulation call from a user interface logic for a selected training scenario of the plurality of training scenarios. In response to receiving the simulation call, the portfolio simulator outputs the simplified and stylized statistical simulation for the selected training scenarios.

### DESCRIPTION OF THE DRAWINGS

Features of exemplary implementations of the invention will become apparent from the description, the claims, and the accompanying drawings in which:

FIG. 1 is a representation of an implementation of a system that comprises a client machine, the Internet, and a user interface logic for a player;

FIG. 2 is a representation of the player engagement tool, the Internet, and a portfolio simulator of an implementation of the system of FIG. 1 and illustrates the portfolio simulator to comprise a graph server, an admin engine, data storage, and a calculation engine;

FIG. 3 is a representation of the graph server, the admin engine, the data storage, and the calculation engine of an implementation of the system of FIG. 2 and illustrates the calculation engine to comprise an input processor, an account simulator, and analytics;

FIG. 4 is a representation of the client machine, the Internet, and the player of an implementation of the system of FIG. 1 and illustrates the calculation engine to comprise a processor, memory, and user interface;

FIG. 5 is a representation of a data server and the admin engine, the data storage, and the calculation engine of the portfolio simulator of an implementation of the system of FIG. 2 and illustrates the data storage to comprise macroeconomic data, portfolio component data, and portfolio performance data;

FIG. 6 is a representation of the player engagement tool of an implementation of the system of FIG. 1 and illustrates the player engagement tool to comprise data storage, classroom based training, and self-guided training;

FIG. 7 is a representation of a division of responsibilities and messages between the player and the Client machine, the player engagement tool, and the portfolio simulator of an implementation of the system of FIG. 1;

FIG. 8 is an example of a plot of percentage of loans going delinquent and credit score as a simplified sensitivity curve that illustrates low sensitivity to rate increase for an entry in macroeconomic data of an implementation of the system of FIG. 5;

FIG. 9 is another example of a plot of percentage of loans going delinquent and credit score as a more complex sensitivity curve for an entry in macroeconomic data of an implementation of the system of FIG. 5;

FIG. 10 is a further example of a plot of percentage of loans going delinquent and credit score as a further complex sensitivity curve that comprises standard deviation, for an entry in macroeconomic data of an implementation of the system of FIG. 5;

FIG. 11 is a representation of a player home page 708 that the user interface logic causes the client machine and the Internet to present to the player of an implementation of the system of FIG. 1 and illustrates the player home page 708 to comprise a module list, a leader board, and module details;

FIG. 12 is a representation of data in tabular form that the user interface logic causes the client machine to present to the player of an implementation of the system of FIG. 1;

FIG. 13 is a representation of data in chart form that the user interface logic causes the client machine to present to the player of an implementation of the system of FIG. 1;

FIG. 14 is a representation of the player engagement tool of the user interface logic of an implementation of the system of FIG. 1 and FIG. 6 and illustrates a flow of the player interacting with the user interface logic;

FIG. 15 is similar to FIG. 14 and illustrates module level details of the flow of the player interacting with the user interface logic;

FIG. 16 is similar to FIG. 8 and illustrates medium sensitivity to rate increase for an entry in macroeconomic data of an implementation of the system of FIG. 5;

FIG. 17 is similar to FIG. 8 and illustrates high sensitivity to rate increase for an entry in macroeconomic data of an implementation of the system of FIG. 5;

FIG. 18 is a representation of an administrator entry form that the user interface logic causes the client machine and the Internet to present to the administrator of an implementation of the system of FIG. 1 and illustrates the entry form to comprise a curve list and curve details;)

FIG. 19 is a representation of a player entry form that the user interface logic causes the client machine and the Internet to present to the player of an implementation of the system of FIG. 1 and illustrates the entry form to initiate a trial scenario of a module;

FIG. 20 is a representation of an administrator entry form that the user interface logic causes the client machine and the Internet to present to the administrator of an implementation of the system of FIG. 1 and illustrates the entry form to create or edit the details of a playable module;

FIG. 21 is a representation of a player entry form that the user interface logic causes the client machine and the Internet to present to the player of an implementation of the system of FIG. 1 and illustrates the entry form to enter management decisions while playing a module's scenario; and

FIG. 22 is a diagrammatic illustration of a high level architecture for implementing processes in accordance with aspects of the invention.

### DETAILED DESCRIPTION

An illustrative embodiment of the present invention relates to a simulator and corresponding method suitable for training and educating. The simulator of the present invention provides a unique simulated environment for use by a trainee or employee to learn business practices without subjecting them to learn by real life experiences and/or mistakes. In particular, the simulator provides real life quality training without the risks, learning curve, and required time required by traditional on the job training methods.

The present invention uses a simplified and randomized statistical simulation that embodies two mechanisms, namely, stylized trends and randomized deviation. The first mechanism of the simulation is referred to as stylized trends, which are historical trends that are modeled in analytical simulations extrapolated from historical data and are crafted by system administrators. These historical trends can have specific key variables that can be exaggerated using the simulator of the present invention demonstrate specific dynamics in portfolio management. For example, in an otherwise standard portfolio setup the simulator can set a variable associated with customer sensitivity to “severe” and collection actions to a “highly sensitive” setting, thereby causing many customers to leave (prepay) if the manager chooses a severe collection policy. Loss of customers means loss of revenue, resulting in a lower portfolio financial outcome and a smaller customer base warranting a negative result from the simulator. The exact shape and inflection points of this customer sensitivity curve are stylized based on historical observation of industry data and phenomena, and can be exaggerated at key points of the curve to ensure the desired learning outcome is reached (e.g., learn how to handle customers with a sensitivity to severe collection actions). The determination of which key data variables are exaggerated is based on the particular subject matter of the simulator being implemented, and the desired outcome or educational impact on the decision making process of a user/player as they are going through the simulation and the corresponding educational or training objectives, as would be readily identifiable and appreciated by one of skill in the art relying upon the present description.

The second mechanism of the simulation, referred to as randomization of deviation, is the bounded randomization and convolution of an underlying trend. The simulator of the present invention presents trends to the player that vary in each trial run, causing the player to carefully analyze and search to understand the underlying trend rather than memorize a particular answer to a particular scenario. The term “randomization” as utilized herein is defined in accordance with the conventional mathematical meaning of the term, for example, randomization is a sequence of random variables describing a process whose outcomes do not follow a deterministic pattern, but follow an evolution described by probability distributions. The term “convolution” as utilized herein is defined in accordance with the conventional mathematical meaning of the term, for example, convolution is a mathematical operation on two functions (f and g), producing a third function that is typically viewed as a modified version of one of the original functions, giving the area overlap between the two functions as a function of the amount that one of the original functions is translated. Additionally, the stylized trends and the randomization of deviation, as utilized by the simulation of the present invention, make up a particular set of rules that provide a marked improvement over conventional training methods and systems. Specifically, the stylized trends and the randomization of deviation enable a computer simulation to produce accurate and realistic simulations of various banking processes related to retail credit that previously could only be through years of hands on experience in a job dealing with such activities.

In a unique discovery learning mode, players learn more effectively if they fail, and then figure out the preferred approach themselves without having to learn from mistakes in real world experience(s). In the case of a failed answer to a provided scenario, the user interface logic first provides a hint to the player or direct the player to context specific training content which will help the player figure out the phenomena. If the player cannot figure out why they are failing, the system must then provide additional hints or direction, but not the correct answer. These context-driven hints are provided by a specific combination of rules that will guide the player to analyze the correct data field and adjust and test their input accordingly. By not giving the player the correct answer, the discovery learning mode forces the player to learn and understand why a particular answer is correct and/or incorrect.

To provide the most efficient guidance, hints, etc., the present invention provides specific user interface logic that can identify a strategy of a player by analyzing the trends of the player. For example, the system user interface logic can identify a trend that the player is losing money because they were lending too aggressively into risky customer groups and granting large loan sizes. Once the system user interface logic has identified the player's strategy or trends, the system provides targeted context-specific hints to the player in line with their game play. For example, if the player is lending too aggressively into risky customer groups, the system can provide a hint counteracting this behavior (e.g., the system can remind the player that setting a lower score cut-off will increase the number of accounts approved, while increasing the loan default rate). Further, the system can provide a reminder and example of the nonlinear nature of the default rate, meaning that there is an exponential increase in default rate relating to the score.

The combination of steps provided by the present invention produces an improved manner for training individuals for a position by providing years' worth of on the job training into a simulator that can provide the same knowledge in a shortened period of time. In particular, the present invention provides a simulation that can be modified to teach a user to learn from mistakes that would normally require on the job training and learning from real life mistakes. Utilizing the present invention enables a company to approach training from an unconventional manner that reduces or eliminates mistakes that are created by employees learning on the job, companies have more effective employees and higher quality of the performance of employees. Additionally, the simulator of the present invention frees up human resources that would normally be allocated to new employee training.

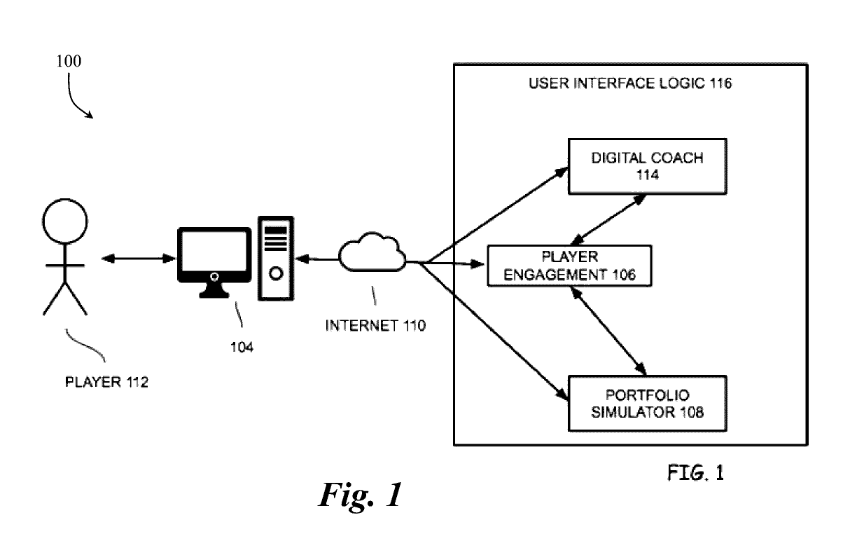

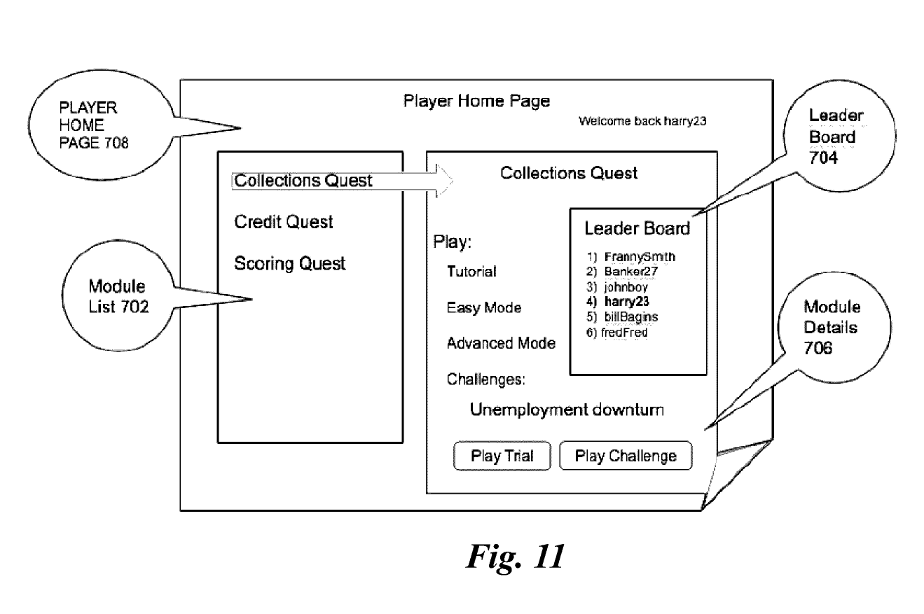

FIG. 1 depicts an implementation of system 100 including a computing device, for example, client machine 104 configured to communicate with other computing devices, for example, over the Internet 110. Additionally, the client machine 104 is configured to provide a user interface logic 116 for utilization in accordance with the present invention. The user interface logic 116, in an example, connects through the Internet 110 to the client machine 104. The client machine 104 presents the user interface logic 116 to a user, for example, a player 112. The player 112, in an example, comprises one or more of a human, a woman, a man, an adult, an elderly person, a child, a player, a trainee, an intern, a customer, an employee, a learner, a student, a graduate, a client, and/or a financial services professional. The client machine 104, in an example, presents the user interface logic 116 to the player 112 through employment of a web browser, for example, through employment of a player home page 708 (FIG. 11). As would be appreciated by one skilled in the art, the user interface logic 116 can be provided to the player 112 through any known means in the art (e.g., software application, web portal, etc.) without departing from the present invention.

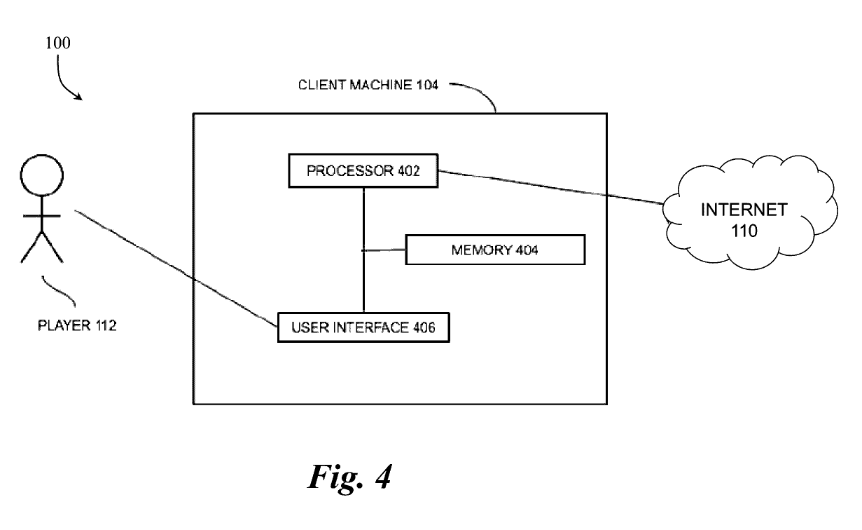

FIG. 4 depicts a representation of the client machine 104 as implemented within the system 100. In particular, FIG. 4 depicts the client machine 104 including a processor 402, memory 404, and user interface 406. Referring to FIG. 1 and FIG. 4, the user interface logic 116, in an example, connects over the Internet 110 to the processor 402 that communicates with the user interface 406. As would be appreciated by one skilled in the art, the client machine 104 can include any combination of a general purpose computer or a specialized computer system. For example, the client machine 104 can include a single computing device, a collection of computing devices in a network computing system, a cloud computing infrastructure, or a combination thereof, as would be appreciated by those of skill in the art.

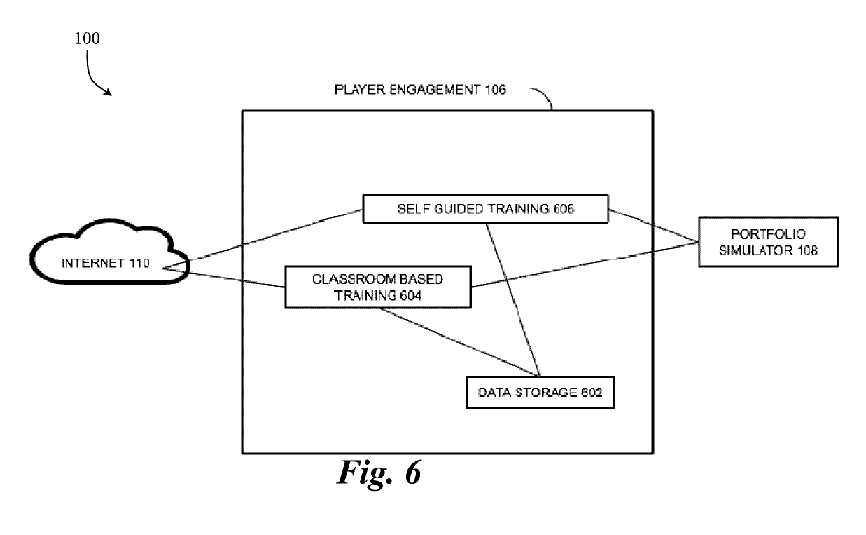

Continuing with FIG. 1, the user interface logic 116, in an example, includes modules or tools for player engagement tool 106, a portfolio simulator 108, and a digital coach 114. The player engagement tool 106, the portfolio simulator 108, and the digital coach 114 can include any combination of hardware and software configured to carry out various aspect of the present invention. Referring to FIG. 6, the player engagement tool 106, in an example, includes software/hardware for data storage 602; classroom based training 604, and self-guided training 606. The data storage 602; classroom based training 604, and self-guided training 606 of the player engagement tool 106 are configured to provide data for utilization by the portfolio simulator 108. The data storage 602 and data storage 208, as would be appreciated to one of skill in the art, can include any combination of computing devices configured to store and organize a collection of data. For example, the data storage 602 can be a local storage device on the client machine 104, a remote database facility, or a cloud computing storage environment. The data storage 602 can also include a database management system utilizing a given database model configured to interact with a user or player for analyzing the database data.

In accordance with an example embodiment of the present invention, the player engagement tool 106 provides a graphic user interface (GUI) for the player 112 to interact with during education and training. For example, referring to FIG. 11, the player engagement tool 106 presents to the player 112, with a GUI on a web page or player home page 708 to provide interaction between the player 112 and the system 100. The user interface logic 116, in an example, causes the client machine 104 and the Internet 110 to present a GUI for the player home page 708 to the player 112. In accordance with an example embodiment of the present invention, the player home page 708 includes a module list 702, a leader board 704, and module details 706. The player 112 can access each of the module list 702, the leader board 704, and the module details 706 within the player home page 708 for more detailed information within the system 100.

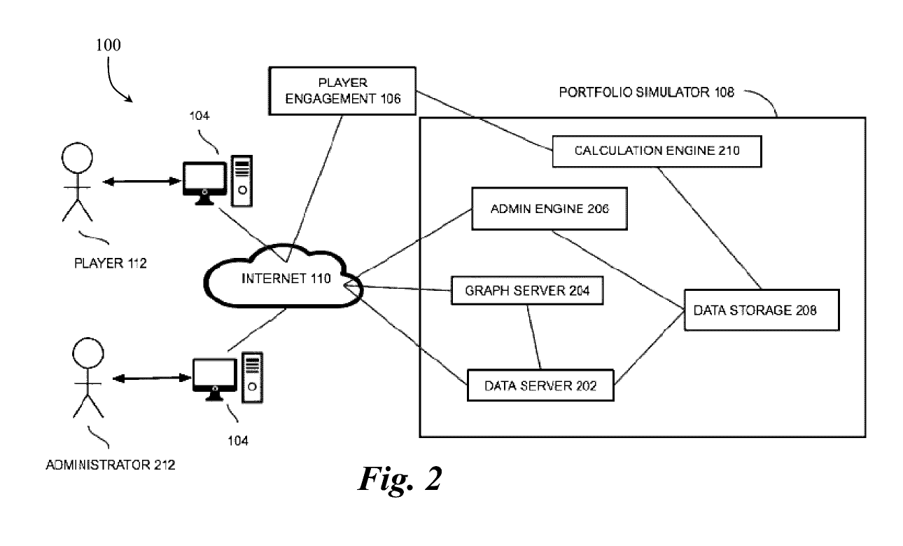

FIG. 2 depicts the portfolio simulator 108 as implemented within the system 100. In particular, FIG. 2 depicts the portfolio simulator 108, in an example, including a data server 202, a graph server 204, an administrator engine or admin engine 206, data storage 208, and a calculation engine 210. In accordance with an example embodiment of the present invention, the portfolio simulator 108 is maintained as a state machine based upon the impact of user input from management decisions provided by the user to the previous state of the state machine. Additionally, the portfolio simulator 108 can provide the player engagement tool 106 with the data to be presented to the player 112 during the simulations including feedback in response to user submitted management decisions. As would be appreciated by one skilled in the art, player 112 and administrator 212 can interact with the portfolio simulator 108 from separate client machines 104 configured to communicate with the system 100 connected over the Internet 110.

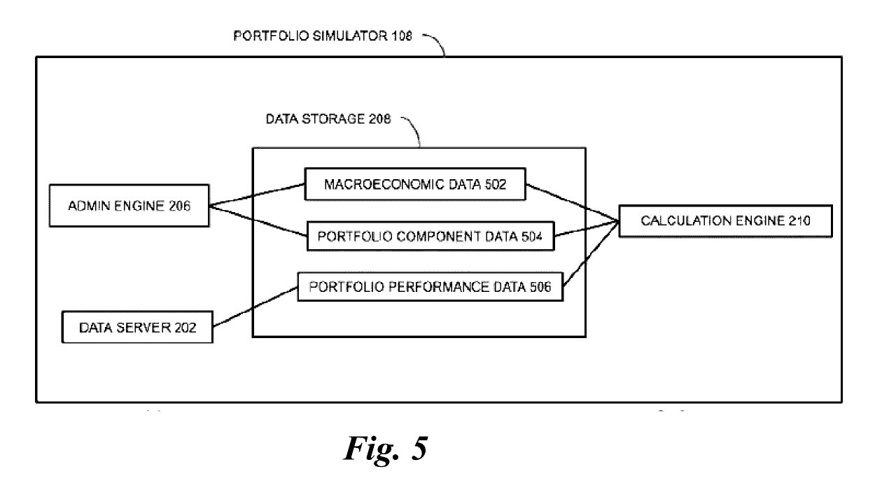

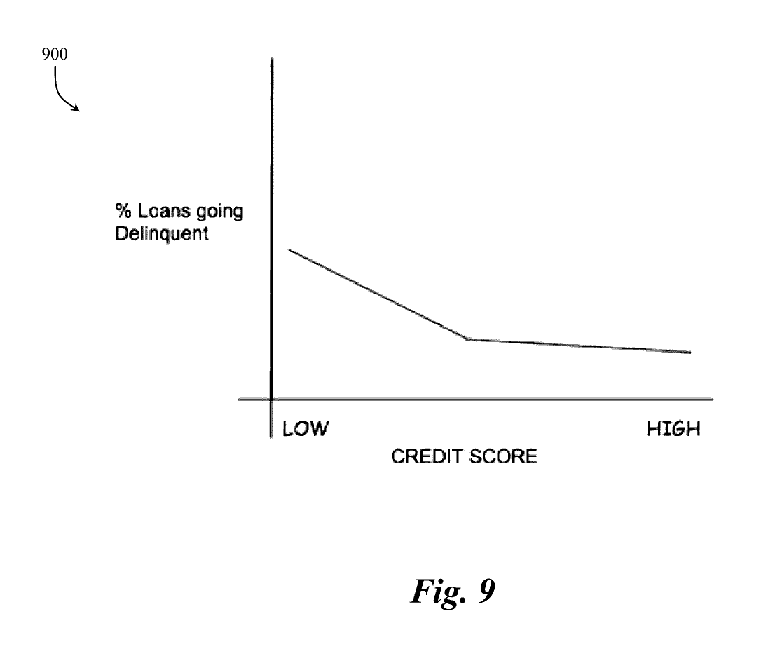

FIG. 5 depicts an example embodiment of the data storage 208 for the portfolio simulator 108 and the types of data stored thereon. In particular, FIG. 5 depicts the data storage 208, in an example, including a macroeconomic data tool 502, a portfolio component data tool 504, and a portfolio performance data tool 506. The macroeconomic data tool 502 stores sensitivity curve data and the associated standard deviations. Additionally, the macroeconomic data tool 502 provides a mechanism for selection, retrieval, and transmission of macroeconomic data for use by the portfolio simulator 108, and the components thereof For example, the sensitivity curve 900, as depicted in FIG. 9, can be stored as macroeconomic data by the macroeconomic data tool 502 to be utilized as an input by the portfolio simulator 108. In particular, the sensitivity curve 900 of FIG. 9 is example of a plot of percentage of loans going delinquent and credit score as a more complex sensitivity curve for an entry in macroeconomic data of an implementation of the system 100.

The portfolio component data tool 504 includes data entered by the administrator 212 (via the admin engine 206) that defines the products (e.g., loans) for use within the portfolio simulator that might be available in a specific scenario. An example of product definitions can include, “An unsecured loan in an emerging market”, and includes data related to base performance curves for the product. The portfolio performance data tool 506 includes the data generated by the portfolio simulator 108 when a product or set of products are subjected to management decisions within a given set of macroeconomic conditions over a simulated period of time, these are the ‘results’ of the simulation. The portfolio performance data tool 506, in an example, can be stored in the data server 202 and accessed by the portfolio simulator 108 during or after a simulation.

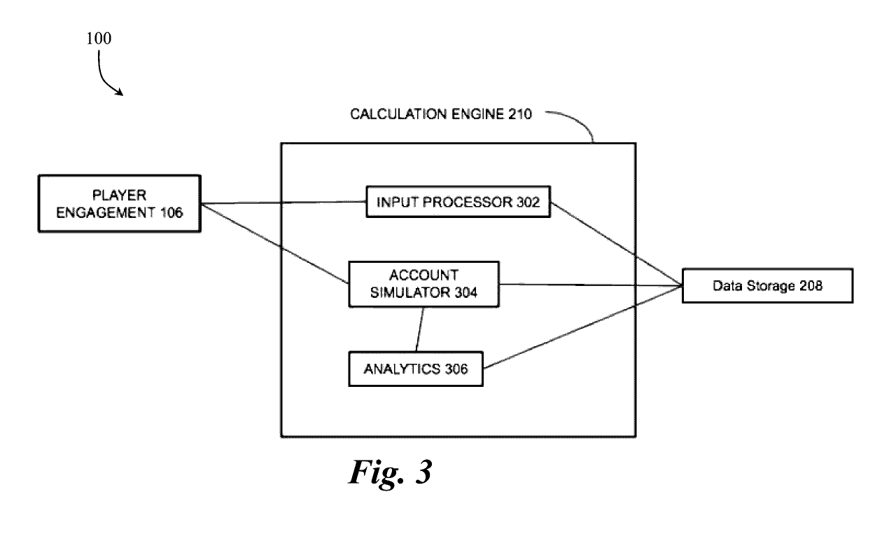

Data from each of the macroeconomic data tool 502, the portfolio component data tool 504, and the portfolio performance data tool 506 can be provided to the calculation engine 210 for processing within the portfolio simulator 108. Referring to FIG. 3, the calculation engine 210 as implemented in the system 100, in an example, includes an input processor 302, an account simulator 304, and an analytics tool 306. Additionally, the calculation engine 210 can be in communication with or otherwise connected to the data storage 208 and/or data storage 602 for providing data for utilization for the input processor 302, the account simulator 304, and the analytics tool 306.

A combination of custom educational material and a statistical simulation logic provided by the user interface logic 116 (including the digital coach 114, the player engagement tool 106, and the portfolio simulator 108), in an example, serves to educate a target audience of players 112 (e.g., retail lending staff). For example, the user interface logic 116 can be used to educate a target audience of underwriters, debt collection managers, portfolio managers, product managers, etc. The training by the user interface logic 116, in an example, serves to empower this audience of players 112 of the simulation provided by the system 100, to understand and anticipate the future impact of their decisions and strategies on customer and portfolio performance.

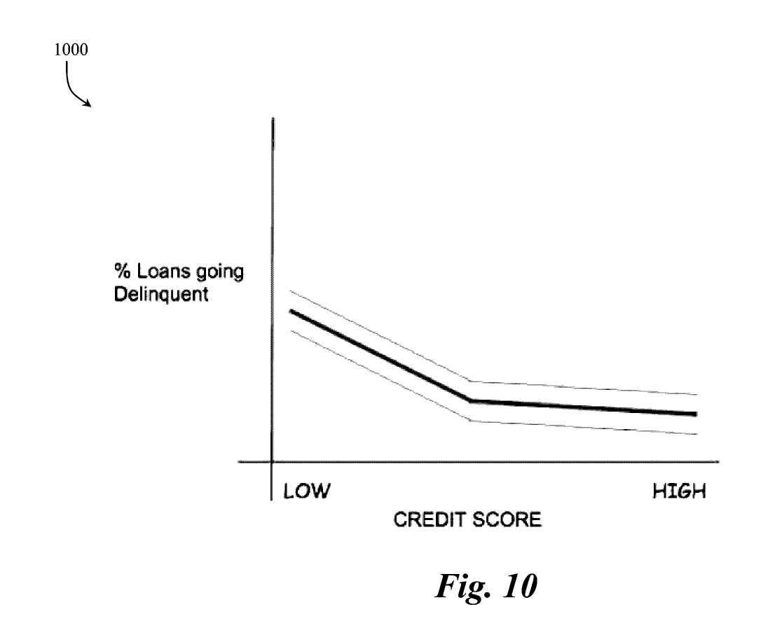

In accordance with an example embodiment of the present invention, the user interface logic 116, specifically the calculation engine 210, creates a stylized and/or synthetic reality and/or simulation for the player 112. For example, the calculation engine 210 creates a simulation that highlights and/or exaggerates identified and/or key phenomena. The highlighted and/or exaggerated key phenomena is based on the data stored by the tools 502, 504, 506 in the data storage 208. The user interface logic 116, in an example, stylizes and/or synthesizes the reality and/or simulation for the player 112 differently than would be a particular portfolio or case study of a historically observed reality. In accordance with an example embodiment of the present invention, data representative of a particular trend or scenario is used as a baseline (e.g., from data storage 208) and can be exaggerated and/or expanded to emphasize a teaching point or phenomena as to how a player 112 should react to similar scenarios. The baseline data can be transformed by randomizing the variables to fall within a predetermined bounded randomization for that particular trend or scenario. As would be appreciated by one skilled in the art, the baseline trend or scenario can be created by using historical data or can be manufactured by a user (e.g., administrator 212). A number of cause-and-effect phenomena are determined to be non-linear in nature and the randomization bounds can be formed around the non-linear pathway 1000, as depicted in FIG. 10. The stylization by the user interface logic 116, in an example, serves to present to the player 112 an exaggerated inflection point that ensures the engaged player as the player 112 will notice the phenomena and learn to recognize the phenomena in the real world through repetitive play of the simulation.

In accordance with an example embodiment of the present invention, to allow players 112 the opportunity for repetition and practice, without the redundancy of using the same scripted scenarios, the user interface logic 116, through player engagement tool 106 employs the bounded randomization and/or data convolution in the portfolio simulator 108. The user interface logic 116, in an example, presents to the player 112 a replayable and dynamic experience, allowing the player 112 to practice in a plurality of scenarios without encountering the same set of variables during each replay. The scenarios presented to the player 112 by the user interface logic 116, in an example, vary in each trial, due to the randomization, with employment of the same underlying phenomena.

In accordance with an example embodiment of the present invention, the digital coach 114 provides digital coaching and feedback to the player 112 during the simulation. The user interface logic 116, in an example, analyzes one or more decisions the player 112 made during a simulated scenario to diagnose the causes and strategy employed by the player 112 to arrive at those decisions. In a discovery learning mode of the digital coach 114, in an example, the digital coach 114 may promote effective learning by the player 112 by indicating to the player a failure of the presented scenario and determining a corrective action for presentation to the player 112 to yield a better result. For example, the user interface logic 116 first provides a hint to the player 112 or directs the player 112 to context specific training content, based on the determination by the digital coach 114, to promote and/or help the player 112 to figure out the phenomena conveyed in the presented scenario. The context specific training content, in an example, is located in the digital coach 114. For example, the context specific training content can include links or pointers to specific chapters or sections in a training manual or reference material. If the player 112 cannot figure out why they are failing, then the digital coach 114, in an example, will continue to provide additional hints or direction until the player 112 arrives at the correct decision.

In addition, the simulator in accordance with the present invention provides a digital coach 114 and feedback. More specifically, the user interface logic 116 analyzes decisions from the player 112 to diagnose the cause and drivers of their decision. In a discovery learning mode, players learn more effectively if they fail, then figure out the result themselves. Therefore, the user interface logic 116 first provides a hint to the player or direct the player to context specific training content which will help the player 112 figure out the phenomena. If the player cannot figure out why they are failing, the system 100 must then provide additional hints or direction, but not the correct answer. These context-driven hints guide the player to analyze the correct data field and adjust and test their input accordingly.

The system user interface logic 116 identifies the strategy being implemented by the player 112 (for example, the player is losing money because they were lending too aggressively into risky customer groups and granting large loan sizes). Once the algorithm has identified the player's 112 strategy, the system 100 provides context-specific hints to the player 122 in line with their game play. Additional game elements added to this process (the ‘hint’ costing something to the player) create additional engagement levels and as a result strengthens the learning outcome.

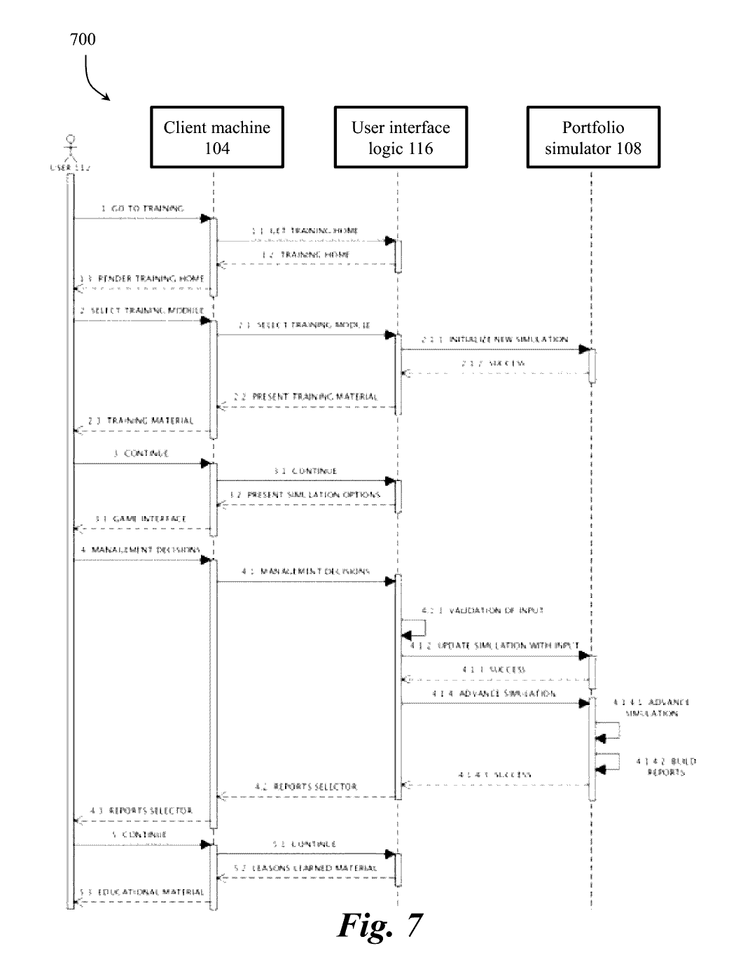

In operation, a player 112 can utilize a client machine 104 to access the system 100 and interact with a simulation provided by the system 100. FIG. 7 shows an exemplary flow chart depicting implementation of the present invention. Specifically, FIG. 7 depicts an exemplary process 700 showing the operation of system 100, as discussed with respect to FIGS. 1-6. In particular, FIG. 7 shows user interactions through the player engagement tool 106. The process 700 starts with the player 112 starting training utilizing the client machine 104 at STEP 1. Upon initialization of the training on the client machine 104, the client machine 104 initiates a request for the training home (e.g., player home page 708) from the user interface logic 116 (STEP 1.1). The user interface logic 116 will respond to the request by providing the training home (e.g., player home page 708) associated with the player 112 to the client machine 104 (STEP 1.2). The client machine 104 receives the training homepage and renders the home page for display to the player 112 (STEP 1.3). As would be appreciated by one skilled in the art, the request and reception of the training home can be executed utilizing any combination of software and hardware known in the art. For example, the client machine 104 can provide the request over the internet 110 to a server providing the user logic interface 116 and hosting the training home page. Similarly, the training home can be rendered on the player's 112 client machine 104 utilizing any combination of software and hardware known in the art (e.g., loading in a web browser).

At STEP 2, the player 112 selects the training module (e.g., from the module list 702) that the player 112 wishes to execute. The selected training module is provided by the client machine 104 to the user interface logic 116 (STEP 2.1). In response to receiving a training module, the user interface logic 116 initializes a new simulation call to the portfolio simulator 108 (STEP 2.1.1). The portfolio simulator 108 responds to the new simulation call with a success acknowledgement (STEP 2.1.2). The success acknowledgement can include providing the data for execution of the selected training module to the user interface logic 116, including training materials. Upon receiving the success acknowledgement (and training module data associated therewith), the user interface logic 116 presents the training materials to the client machine 104 (STEP 2.2.). Thereafter, the client machine 104 renders the training material for display to the player 112 (STEP 2.3). In accordance with an example embodiment of the present invention, the training material is context specific information pertinent to the management decisions the player is making in the user interface logic (e.g., the player engagement tool 106). The training material explains the underlying phenomena of customer and portfolio behavior, which will assist the player in understanding the cause and effect of their management decisions. For example, the training material can explain that as the credit score cutoff increases, the volume and revenue in the portfolio declines, while the delinquency and default rates decrease. In this example, the training material would remind the player that the relationship is not linear. This should assist they player when they analyze the portfolio results.

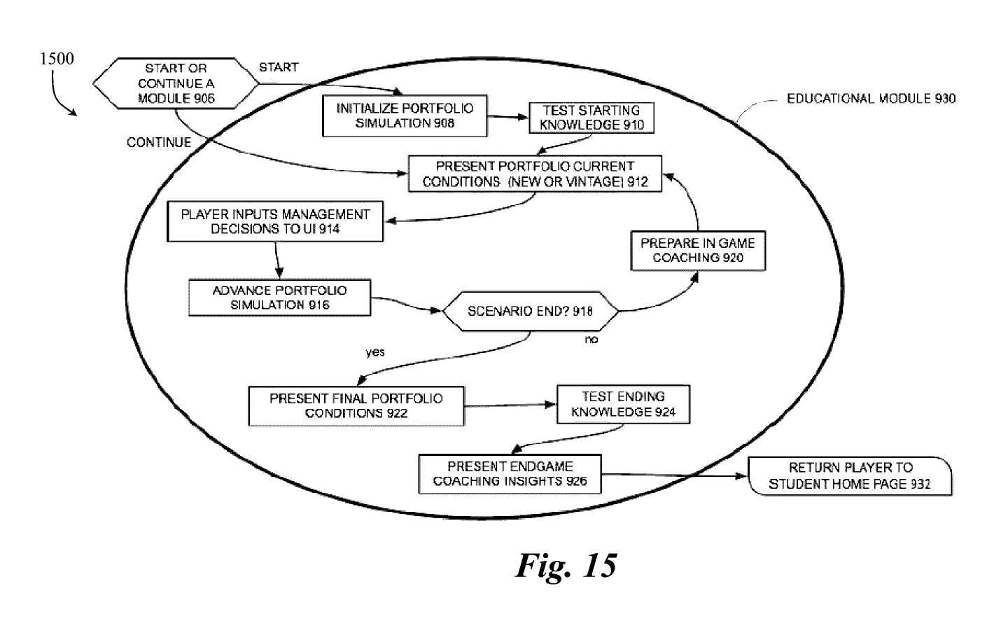

At STEP 3, the client machine 104 receives instructions from the player 112 to start or continue the training module (as discussed in greater detail with respect to STEP 906 of FIG. 15). The client machine 104 passes the instruction to start or continue the training module to the user interface logic 116 for processing (STEP 3.1). The user interface logic 116 responds to the start or continue instruction by providing the simulation options (previously received from the portfolio simulator 108) for the training module back to the client machine 104 (STEP 3.2). The simulation options are provided to the player 112 by the client machine 104 as part of the game interface (e.g., rendered on the player home page) (STEP 3.3).

At STEP 4, management decisions are received, by the client machine 104, from the player 112. The management decisions are provided by the client machine 104 to the user interface logic 116 for processing (STEP 4.1). Thereafter, the user interface logic 116 validates the input provided within the management decisions. The validation of the input includes determining whether the management decisions provided by the player 112 match the expected responses for the presented simulation options (STEP 4.2). As would be appreciated by one skilled in the art, the determination can include performing any comparison steps known in the art. For example, the determination can include comparing the management decisions for the simulation options to answers stored in a database.

After performing the validation steps, the user interface logic 116 provides updated inputs of the simulation to the portfolio simulator 108 (STEP 4.1.2). The portfolio simulator 108 can provide a success acknowledgement to the user interface logic 116 (STEP 4.1.3). Upon receipt of the success acknowledgement, the user interface logic 116 provides an advance simulation call to the portfolio simulator 108 (STEP 4.1.4). In response to the advance simulation call, the portfolio simulator 108 advances the simulation (STEP 4.1.4.1) and builds reports for the simulator (STEP 4.1.4.2). Additionally, the portfolio simulator 108 provides feedback and reports to the user for use during the simulation including prior to the user submitting management decisions and after receiving the user submitted management decisions. For example, the portfolio simulator 108 can provide variables for under or over allocating a budget constraint to produce suggestions/warnings to the player. In another example, the portfolio simulator 108 can evaluate a decision provided by the user that is technically possible but out-of-policy. If an out-of-policy decision is provided, the portfolio simulator 108 can provide the appropriate feedback for the player (e.g., decision is incompatible with policy A).

After completing the processing in STEPS 4.1.4.1 and 4.1.4.2, the portfolio simulator provides a success acknowledgement to the user interface logic 116 including data necessary for providing a report back to the player 112 (e.g., variables or feedback) (STEP 4.1.4.3). In particular, reports and tabular data provide feedback to the user based on the impact of the user provided management decisions provided to the portfolio simulator 108. The user interface logic 116 compiles a reports selector based on the data received from the portfolio simulator 108 and provides the reports selector to the client machine 104 (STEP 4.2). The client machine 104 renders the received reports selector to the player 112 (STEP 4.3). The reports can include any combination of information provided by the system 100 and can be displayed in any displayable format. For example, the display to the user can include a menu of tabular and graphical reports that reflected historical and snapshot view of the portfolio.

At STEP 5, the player 112 provides instructions to the client machine 104 to continue the simulation. The client machine 104 provides the instructions to continue to the user interface logic 116 (STEP 5.1). The user interface logic 116 determines lessons learned material and provides the lessons learned material to the client machine 104 (STEP 5.2). In particular, the digital coach 114 can provide instructions and/or education materials to the user to teach the user lessons based on the user management decisions. For example, the digital coach 114 can identify the user behaviors related to a lack of experimental breadth, report monitoring, or appropriate report analysis and provide the appropriate education materials to improve the user behavior. The client machine 104 provides the educational material associated with the lessons learned materials to the player 112 (STEP 5.2).

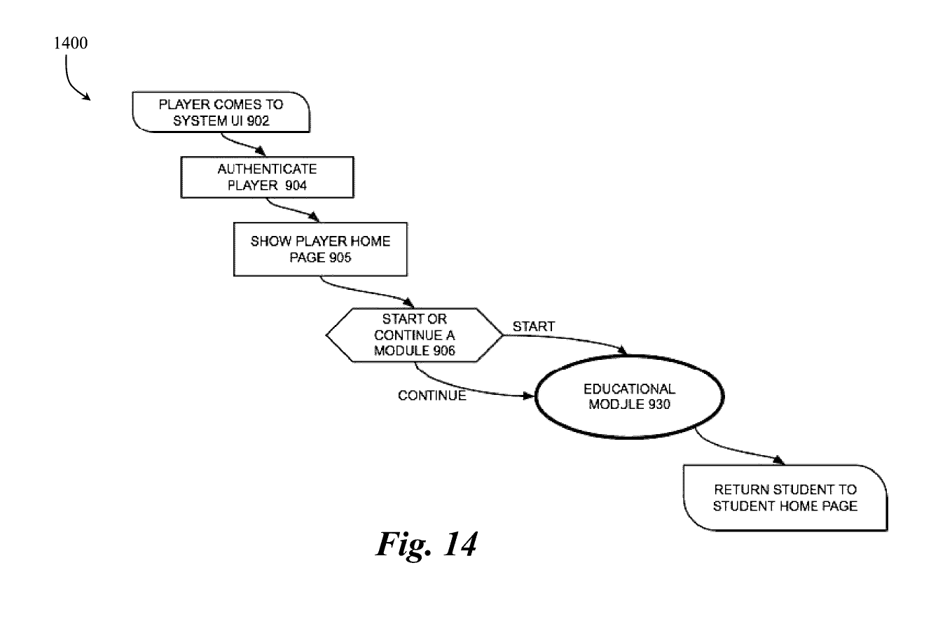

FIGS. 14-15 depict an implementation of the processes 1400, 1500 provided by the digital coach. For example, FIG. 15 depicts the steps within process 1500 in which the digital coach 114, in an example, provides the additional hints or direction during game play at STEP 920 or after game play at STEP 926, as described herein with respect to process 1500. In operation, the digital coach 114, in an example, refrains from presenting to the player 112 the correct answer during a simulation. Instead, the digital coach 114, in an example, employs context-driven hints to guide the player 112 to analyze the correct data field for arriving at the correct answer and correspondingly and/or commensurately adjust and test input from the player 112 to the user interface 406 (FIG. 4).

FIG. 15 provides a series of steps that the portfolio simulation can follow based on user actions/inputs. Initially, the player 112, in an example, inputs their decisions into the user interface 406 (e.g., at STEP 914), and as part of their decisions might select to charge a very high interest rate on the loans in their portfolio. In response to receiving the input from the player 112, the portfolio simulation advances to STEP 916, and the results of the player decision are available for use by the digital coach 114. For example, the digital coach 114 may utilize the player decision in the Prepare In Game Coaching STEP 920. During the In Game Coaching STEP 920, the digital coach 114 employs a set of unique algorithms which identify the cause of the player 112 failure (or success) by comparing the player decisions to correct result stored in the database (e.g., data storage 208). Additionally, the database contains a predetermined list of player decision combinations which player decisions are linked to coaching content in the database. For example, a player's incorrect decision of loan approval parameters in a particular scenario may be associated with a number of predetermined hints and/or context specific content in the database that can be relayed back to the user by the digital coach 114.

Based on a comparison of a player 112 decision and the linked to coaching content in the database, the digital coach 114 prepares the specific content to the player 112. In this example, the in game coaching content reminds the player that a high loan price will tend to result in higher profit margin, and a smaller number of customers (since they would prefer to take a less expensive loan from another lender). Additionally, in this example, the in game coaching content would also remind the player 112 that the player's portfolio may have attracted a larger proportion of risky customers because they were unable to obtain credit from other lenders, a phenomena commonly referred to as “adverse selection”. The hints and context specific content are provided to the player 112 to assist the player 112 in recognizing adverse selection scenarios and dissuade the player 112 from making poor decisions when presented with these phenomena.

In accordance with an example embodiment of the present invention, the in game coaching also directs the player 112 regarding which data series at present portfolio current conditions that the player 112 can analyze to detect these phenomena (as shown in STEP 912). In this example, the player 112 would be directed to focus their attention on certain data series, such as net interest margins, number of loans booked and the delinquency rate.

The player 112, in another example, inputs their decisions into the user interface 406, and as part of their decisions might select a low cut-off score, which would approve a larger proportion of credit applicants. In this example, the In Game Coaching provided by the digital coach 114 presents content to the player 112 explaining that a low cut-off score will result in a larger portfolio, but with a likelihood of a higher default rate. In this example, the digital coach 114 presents content which reminds the player that they should test different cut-off scores, each time analyzing the resulting portfolio size of approved applicants, and the loan default rates in order to determine a more optimal cut-off score. The In Game Coaching provided by the digital coach 114 will also direct the player 112 regarding which data series to reference. In particular, the digital coach 114 can present current portfolio conditions to the player 112 and the player 112 can utilize the conditions to analyze and detect the proper phenomena. In this example, the player 112 would be directed to review the data series related to a number of loans booked, net income after credit losses, and the delinquency rate.

In accordance with an example embodiment of the present invention, referring to FIG. 5, the portfolio simulator 108, in an educational setting, serves to smooth out and/or exaggerate trends and phenomena to ensure particular learning objectives for the player 112. In particular, the portfolio simulator 108, in an example, serves to stylize and recreate phenomena (in a simulation) observed in the real world, in a controlled yet complex manner. The portfolio simulator 108, in an example, employs a simplified and stylized statistical simulation which can include but is not limited to time-domain convolution and principle of superposition, as would be readily understood by those of skill in the art in view of the present description. Specifically, the administrator 212 has identified key variables associated with a given phenomenon and crafted them into algorithms in the portfolio simulator 108 and saved in the data storage 208. For example, these key variables can be identified by identifying a combination of variables during particular historical events that caused a certain resulting phenomenon. By identifying the key variables and/or combination of variables, and crafting algorithms which represent those phenomena, the portfolio simulator 108 can establish a baseline scenario. As would be appreciated by one skilled in the art, the key variables and combination of variables can be predetermined values determined through historical analysis, created by an administrator 212 as synthetic data, or a combination thereof. Using the baseline variables, the portfolio simulator 108 can randomize the values of the variables and smooth out and/or exaggerate those variables within a particular range (e.g., through bounded randomization). Additionally, the portfolio simulator 108, in an example, employs stylized trends and/or randomized deviation from those trends.

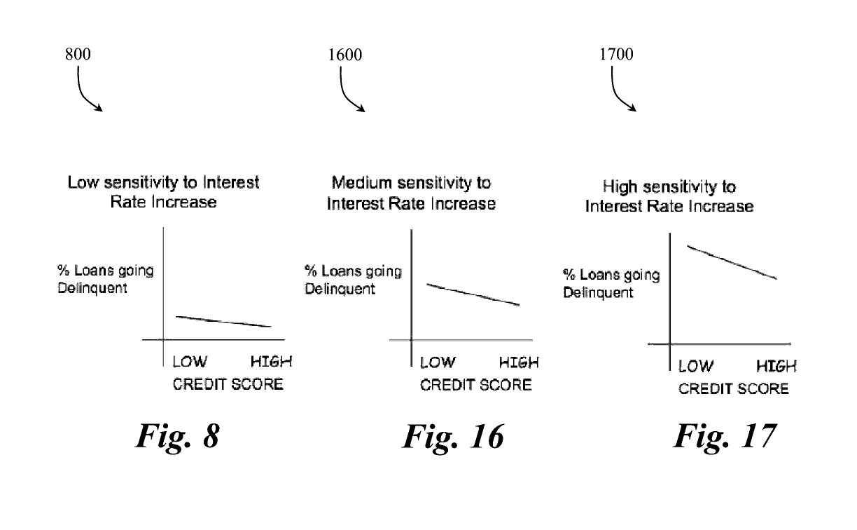

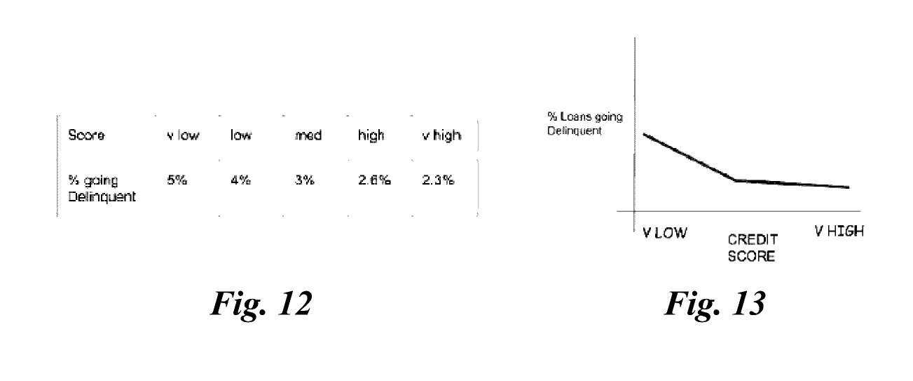

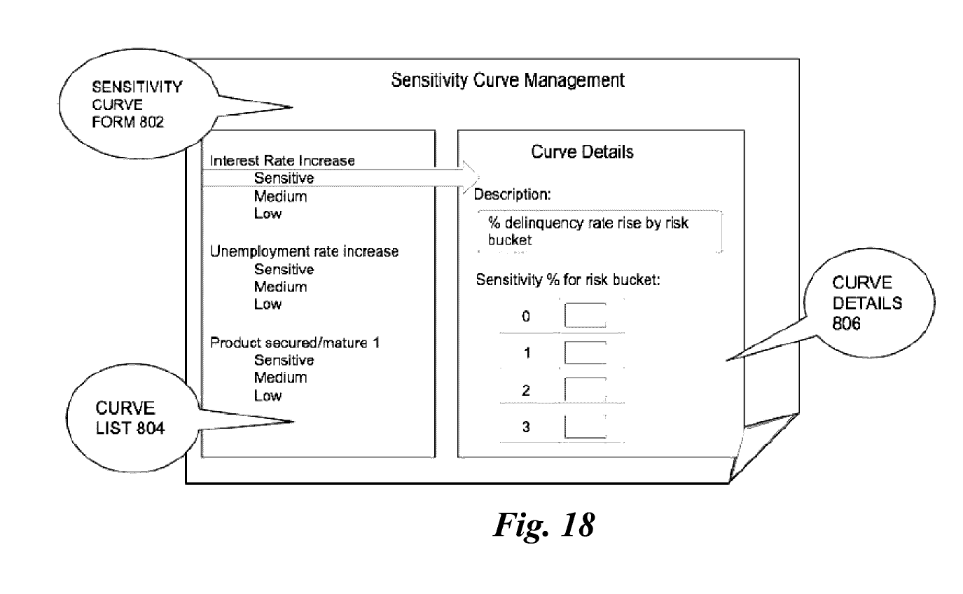

In accordance with an example embodiment of the present invention, referring to FIG. 18, the player engagement tool 106 provides a form, sensitivity curve form 802, for the management of sensitivity curves (by an administrator 212) that are stored in macroeconomic data tool 502. In an example all of the available sensitivity curves (e.g., sensitivity curves such as the sensitivity curve as depicted in FIGS. 8, 9, 13, 16, and 17) are displayed, by player engagement tool 106, in curve list 804. FIG. 8 is an example of a plot of percentage of loans going delinquent and credit score as a simplified sensitivity curve that illustrates low sensitivity to rate increase for an entry in macroeconomic data. FIG. 9 is another example of a plot of percentage of loans going delinquent and credit score as a more complex sensitivity curve for an entry in macroeconomic data. FIG. 13 is a graphical representation of the data from FIG. 12. FIG. 13 demonstrates an inflection point at the third data point within FIG. 12. FIG. 16 is similar to FIG. 8 and illustrates medium sensitivity to rate increase for an entry in macroeconomic data. Lastly, FIG. 17 is similar to FIG. 8 and illustrates high sensitivity to rate increase for an entry in macroeconomic data. When a specific curve from one of FIGS. 8, 9, 13, 16, and 17 is selected in curve list 804 the player engagement tool 106 displays the curve, makes editable for an administrator 212, and stores the details of that curve in curve details 806 for use by the portfolio simulator 108.

Continuing with FIG. 18, in accordance with an example embodiment, the administrator 212 manually selects and enters sensitivity values into the sensitivity curve form 802 to establish the available stylized trends. Referring to FIGS. 8-10 and 16-17, the stylized trends, in an example, are observed in historical data and admin engine 206 and provide forms for the entry of the stylized trends as data crafted by the administrator 212. Stylized trends, in an example, can be provided to create baselines of specific variables that can be exaggerated to demonstrate specific dynamics in portfolio management. In accordance with an example embodiment of the present invention, data entered in sensitivity curve form 802 of admin engine 206 can be synthetic data.

In accordance with an example embodiment of the present invention, referring to FIG. 17, in a portfolio setup the player engagement tool 106 facilitates a player 112 or an admin engine 206 facilitates an administrator 212, to set “customer sensitivity to severe collection actions” to be very sensitive, in a similar manner as discussed with respect to FIG. 17, causing many customers to leave (prepay) if the player 112 chooses a severe collection policy. Loss of customers means loss of revenue, resulting in a lower portfolio financial outcome and a smaller customer base.

The second mechanism of portfolio simulator 108 is the bounded randomization and convolution of the underlying trend as implemented, in the example, in calculation engine 210. In an example, during initialize portfolio simulation (e.g., at STEP 908), the calculation engine 210 generates between 50,000 to 250,000 simulation accounts for utilization during the simulation. For example, the simulation accounts can include loans with a certain distribution of loans by credit score. This data is generated by account simulator 304 using random number generators and parameters from portfolio component data tool 504 so that the player 112 does not encounter exactly the same data in each test run.

In accordance with an example embodiment of the present invention, the user interface logic 116 presents trends or scenarios to the player 112. Based on the configured scenarios and related data, the trends can vary in each trial run by a standard deviation as shown in FIG. 10. In particular, FIG. 10 depicts a baseline value with upper and lower bounds created by the standard deviation. The calculation of the deviation, in the example, is implemented by calculation engine 210, causing the player 112 to carefully analyze and search to understand the underlying trend.

In accordance with an example embodiment of the present invention, referring to FIG. 14, game play as presented to the player 112, by the player engagement tool 106 and as part of the user interface logic 116, is presented in educational module 930. Educational modules 930 are a combination of logic encoded in player engagement tool 106 and data in data storage 208. In operation, a player 112 selects which educational module 930, they want to play on player home page 708, provided by the module list 702. Educational modules 930 could be considered specific classes or lessons programmed in the system 100. In particular, each educational module 930 can be designed to teach lessons pertaining to a specific part of the portfolio management lifecycle (e.g., the four parts of the life cycle accepted as common knowledge in the industry are account acquisition, underwriting, account management and collections/recovery). In accordance with an example embodiment of the present invention, educational modules 930 are defined by the administrator 212 via the admin engine 206.

In accordance with an example embodiment of the present invention, the player home page 708, as depicted in FIG. 11, provides the module list 702. In an example, in the module list 702 there is a “Collections Quest” option that teaches about collections management and a “Credit Quest” option that teaches about loan origination. As would be appreciated by one skilled in the art, each “Quest” from the module list 702 can include numerous different educational simulations to test/educate the player 112. To create a new educational module 930, new logic must be encoded in player engagement tool 106 but this new logic will be configured by administrator 212 to use common data stored in data storage 208. Each educational module 930 will provide multiple scenarios.

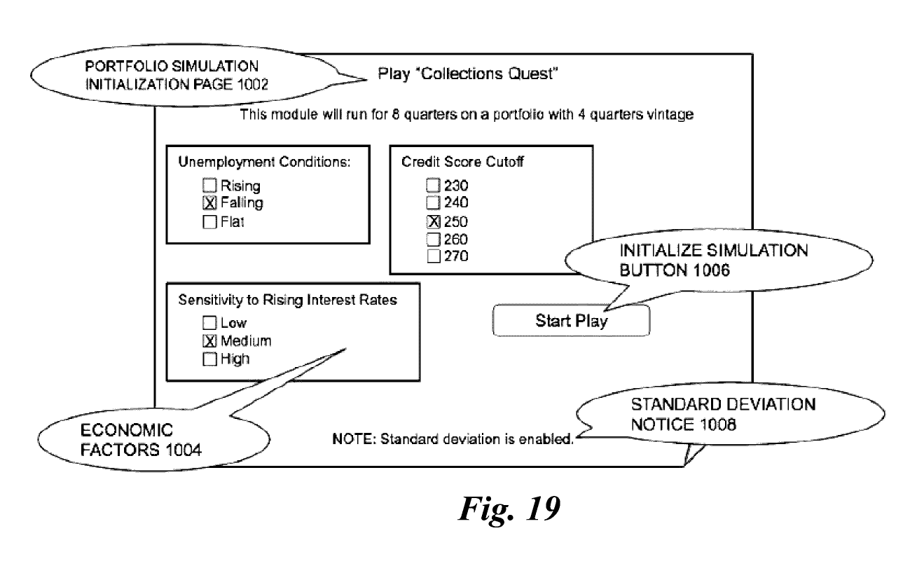

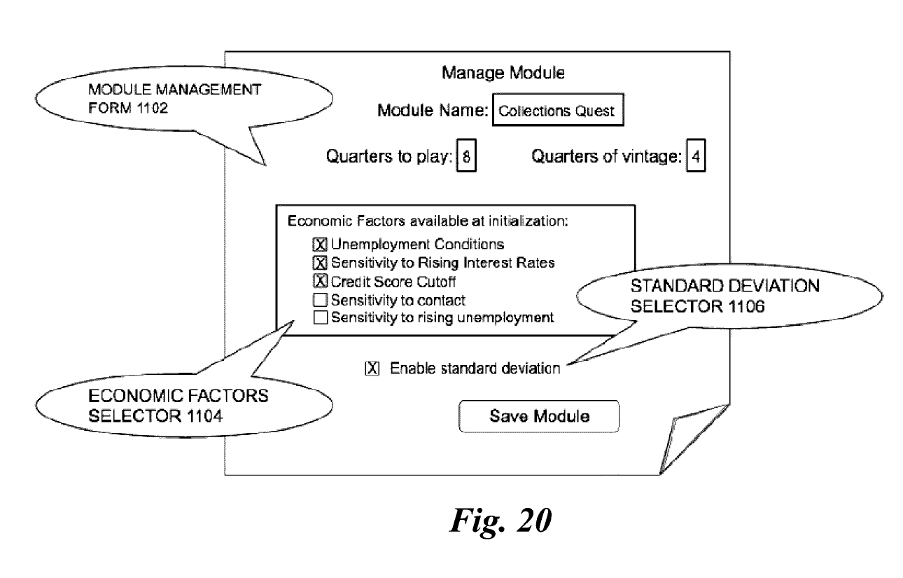

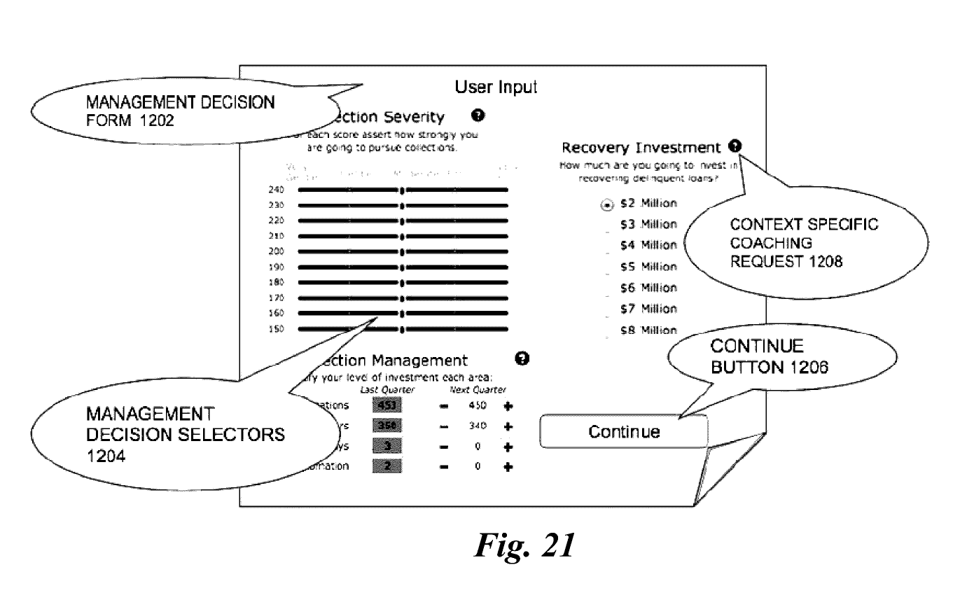

In accordance with an example embodiment of the present invention, when the player 112 plays an educational module 930 presented by the player engagement tool 106, the player 112 plays a scenario within that educational module 930. In particular, when the player 112 starts playing an educational module 930 in trial mode, the player engagement tool 106 presents the player 112 with choices on portfolio simulation initialization page 1002 as shown in FIG. 19. As depicted in FIG. 19, the economic factors 1004 that establish the trial scenario will be selected by player 112. The limits of user choice for a scenario are inherent in the definition of the educational module 930 as defined by administrator 212. For example, the administrator 212 defines educational module 930 via the module management form 1102, as shown in FIG. 20. The choices available to administrator 212 in economic factors selector 1104 are derived from the data in macroeconomic data tool 502. The data established, in an example, by the administrator 212 via sensitivity curve form 802 from FIG.

18.

A player 112, in an example, can run as many trials of an educational module 930 as the player 112 wishes. At the start of each trial run, in an example, the player 112 can select via the portfolio simulation initialization page 1002 from the player engagement tool 106 a different combination of economic factors 1004 that will influence the dynamics (e.g., baseline and associated variables) within the portfolio simulator 108. Each educational module 930, in an example, includes a different set and different number of settable economic factors defined via the module management form 1102.

As a simple example, an educational module 930 defined in the admin engine 206 with three economic factors 1004 available, as shown portfolio simulation initialization page 1002 in FIG. 19, is presented to the player 112 in the Initialize Portfolio Simulation (e.g., at STEP 908). From the portfolio simulation initialization page 1002 the player 112 can select the unemployment conditions, as defined in macroeconomic data tool 502, sensitivity to interest rate rising, as also defined in macroeconomic data tool 502, and can select the credit score cutoff which is encoded in account simulator 304.

In accordance with an example embodiment of the present invention, an administrator 212 defines an educational module 930 via the module management form 1102. The number of base scenarios available in that educational module 930 can be calculated in the following way: For all of the economic factors 1004 available at when initializing the portfolio simulation (e.g., at STEP 908), multiply the number of options for the economic factor by the number options for the next economic factor. Take the result and multiply it by the number of options on the next economic factor and repeat until all of the economic factors have been included. The result is the number of base scenarios for an educational module 930. In an example of figuring out a number of base scenarios, utilizing the options shown in FIG. 19, the calculation would be: three options on unemployment multiplied by five options on credit score cutoff multiplied by three options on interest increase sensitivity to equal seventy five base scenarios.

While standard deviation is enabled, as it is in the FIG. 19 example, results of playing the exact same base scenario (same setting for all three factors) with exactly the same management decisions during play would still result in different outcomes because of the randomization of the variables for each simulation. The standard deviation, in an example, is encoded by calculation engine 210. In an example there are in a simulation 100,000 accounts and the sensitivity curve shows that 2% of the accounts will default. If the standard deviation is disabled then 2,000 accounts will default. If standard deviation is enabled at +−1% then ‘between 1,000 and 3,000 accounts will default depending on random selection.

In accordance with an example embodiment of the present invention, a player 112 can access and play, via the player home page 708, as many trials/simulations of an educational module 930 as the player 112 has available. In an example the administrator 212 completes the module management form 1102 and enables standard deviation using standard deviation selector 1106. In this example, when the player 112 is playing in trial mode the economic factors 1004 will be calculated in each trial run with a standard deviation around the underlying trend, as depicted in the graph illustrated in FIG. 10. In accordance with an example embodiment of the present invention, the standard deviation can be enabled via the module management form 1102 depicted in FIG. 20. In particular, FIG. 20 depicts enabling standard deviation selector 1106, which causes the calculation engine 210 of portfolio simulator 108 to randomize the results of a scenario within a range from the norm. This deviation enabled means that playing the exact same educational module 930 with the same settings and input will result in slightly different results being saved in portfolio performance data tool 506 and being presented to the player 112 via player engagement tool 106. This ensures that the player 112, in an example, must learn the underlying economic dynamics rather than learning how to “game-the-game” (e.g., memorizing answers to the same questions).

The results of trial runs performed by the player 112 are stored in portfolio performance data tool 506 and can be reviewed for educational purposes via the player engagement tool 106. For example, the data is accessible for presentation in tabular for via data server 202 or in graphical representation via graph server 204. The results of trial runs, in an example, do not affect the ranking of the player 112. The data about game play is stored in the data storage 602 and that in turn references a specific set of simulation run data in the portfolio performance data tool 506. In an example, the administrator 212 creates an educational module 930 and a player 112 initializes a portfolio simulation (e.g., at STEP 908), inputs decisions to UI (e.g., inputs their decisions at STEP 914), and reaches the scenario end (e.g., at STEP 918). In accordance with an example embodiment of the present invention, the portfolio and financial results as calculated by the calculation engine 210 and are stored in the data server 202. For example, each time a player 112 reaches the scenario end (e.g., at STEP 918) or the test ending knowledge (e.g., at STEP 924), these results are stored in the data server 202.

In accordance with an example embodiment of the present invention, all educational modules 930 as presented via player engagement tool 106, in an example, have associated Challenges. Challenges, in an example, include a set of economic factors from the macroeconomic data tool 502 which are preconfigured via the admin engine 206 to simulate specific realistic and challenging scenarios. As would be appreciated by one skilled in the art, the administrator 212 may craft additional sensitivity curves specifically for a challenge via the sensitivity curve form 802 which will be saved into macroeconomic data tool 502 for use in that challenge and available for future scenarios. When a player 112 is playing an educational module 930 in challenge mode, in an example, the standard deviation in the sensitivity curves is disabled in the calculation engine 210 so that each player 112 has the exact same chance of performing well or poorly. New challenges will be released periodically and will be available to play for a designated period of time. The administrator 212, in an example, can release new challenges to players 112 by selecting a set of parameters in the admin engine 206 which will create a new challenge available to players 112. The administrator 212, in an example, can select settings in the admin engine 206 which will make the challenge available to a selected group of players 112 for a selected period of time.

The player engagement tool 106, in an example, enforces that each player 112 can only play a given or each challenge once. As a result of completing an educational module 930 challenge, the player engagement tool 106 will update the ranking (cumulative score) of the player 112 in the data storage 602. Once a challenge has been closed the player engagement tool 106, in an example, makes the challenge available to play in the trial mode so players 112 that missed the challenge or wish to explore improvements can do so. Playing challenges after they are closed in the trial mode in an example does not cause player engagement tool 106 to update a ranking of the player 112.

The player engagement tool 106, in an example, manages ranking within the challenge system so that the ranking will vary by educational module 930 and even by challenge. The Key Performance Indicators (KPI) for a specific challenge, in an example, will be explicit in the challenge description stored in data storage 602. One challenge, in an example, may have a KPI of “make as much money as possible” while another may be “keep overhead as low as possible while staying profitable.” Ranking, in an example, is established by player engagement tool 106 based on a combination of player 112 performance vs. other players 112 and player 112 performance vs. optimal computed results as computed by player engagement tool 106 running tests with portfolio simulator 108.

In accordance with an example embodiment of the present invention, the player engagement tool 106 will enable players 112 to be placed into or join leagues for comparing rankings. Commonly leagues, in an example, will be departmental letting team members compete. The user interface logic 116 also provides the ability to create broader and ad-hoc leagues for broader competition.

In accordance with an example embodiment of the present invention, the Player Home Page 708 is presented by the user interface logic 116 and will act as a dashboard showing what has been played, what is available to play and where the player ranking stands in the available leagues.

An illustrative description of an exemplary operation of an implementation of the system 100 is presented, for explanatory purposes. Referring to FIGS. 14-15, the player 112, in an example, interacts with the user interface logic 116. In particular, FIG. 14 depicts the process for a player 112 initializing a simulation provided by the system 100, starting at STEP 902. To facilitate (e.g., at STEP 902) of the player 112 coming to the user interface 406 (FIG. 4) as a system user interface (UI), the user interface logic 116, in an example, employs a well-known or easily-located Internet address (uniform resource locator, URL) where any player 112 or potential player 112 can start interaction with the user interface logic 116. The user interface logic 116, in an example, takes the player 112 to purchase access, or register, to play the game. A registered individual is known to the user interface logic 116 as a player 112. Players 112 can enter their player identification and authenticate themselves to the user interface logic 116 via player engagement tool 106. The user interface logic 116, that welcomes individuals and registers them as players 112, is generated by its component part player engagement tool 106. Referring to FIG. 6, the modules for self-guided training 606 and the classroom based training 604 of the player engagement tool 106, in an example, employ distinct and separate well-known or easily-located Internet addresses that correspond in an example to distinct groups of players 112. In a further example, a player 112 could be registered in a plurality of playable environments the modules for self-guided training 606 and the classroom based training 604 of the player engagement tool 106.

In accordance with an example embodiment of the present invention, to facilitate authentication of a player 112 (e.g., at STEP 904), all players 112 have registered a unique identifier (username) and password with the user interface logic 116 and must provide those to prove their identity to the user interface logic 116. Once player engagement tool 106 has established a reasonable level of confidence in the identity of the player 112, the player engagement tool 106, in an example, will present to the player 112 the player home page 708 associated with the player 112 (e.g., at STEP 905). Self-guided training 606, classroom based training 604 and any future player engagement tool 106, in an example, implements authentication to establish a high level of confidence in the identity of the player 112.

When displaying a player home page 708 (e.g., STEP 905) the player 112 is presented with a player home page 708 as shown in FIG. 11, as an example. In that example, the player engagement tool 106 provides player 112 with a list of playable educational modules 930 in a module list 702. In this example, when a specific educational module 930 is selected in the module list 702, the player engagement tool 106 displays details about that educational module 930 in the module details 706. Additionally, when an educational module 930 is selected, the current player 112's cumulative score and relative league position is displayed in the leader board 704.

In accordance with an example embodiment of the present invention, when the player 112 elects to start or continue a module (e.g., at STEP 906) from the Player Home Page 708, the player 112 either starts playing a scenario or continues playing a scenario that the player 112 started earlier but did not complete. In particular, when a player 112 starts or continues a module, as provided in STEP 906, both processes 1400 and 1500 as depicted in FIG. 14 and FIG. 15, respectively, are utilized. With respect to process 1400, the user interface logic 116, in an example, advances from the initialization STEP 906 to the educational module 930 which ensures that only one scenario can be current at a time. To start a new scenario if one is already in progress, in an example, the user interface logic 116 forces the player 112 to either complete or abandon the previous scenario. If a player 112 is starting a new educational module 930 scenario, in an example, the user interface logic 116 returns the player 112 to initialize the portfolio simulation at STEP 908 of process 1500. Otherwise, in an example, if the player 112 is continuing a scenario within the process 1500, then the player 112 will be sent to present portfolio current conditions at STEP 912.

To facilitate initializing of the portfolio simulation at STEP 908, in accordance with the process 1500, when a player 112 starts a new scenario in an educational module 930, the user interface logic 116 presents the player 112 with some choices that will govern the borrower behavior and economic conditions of the scenario these choices are presented via portfolio simulation initialization page 1002 (as depicted in FIG. 19). Once player 112 has finalized their choices they click initialize simulation button 1006 and these choices are stored by player engagement tool 106 in data storage 602 or data storage 208. Which factors are presented for selection depend on the specific educational module 930 as preconfigured via the admin engine 206. Once the player 112, in an example, has made the initial selections of the player 112, in an example, player engagement tool 106 causes the portfolio simulator 108 to initialize the simulation.

In the initialization of the portfolio simulation at STEP 908, in an example, the player engagement tool 106 communicates with the portfolio simulator 108. The calculation engine 210, in an example, calls on macroeconomic data tool 502 and portfolio component data tool 504 to retrieve sensitivity curves (e.g., curves such as the curves in FIGS. 840, 16, 17) and product definitions. The calculation engine 210 initializes and writes the scenario to the portfolio performance data tool 506 (as depicted in FIG. 5). In accordance with an example embodiment of the present invention, the macroeconomic data tool 502 and the portfolio component data 504 is synthetic data based on algorithms to enable creation of a specific lending environment. For example, the algorithms can include metrics related to unemployment versus 1-30 delinquency, collective severity versus customer attrition, etc. This enables strict control over a vast number of variations which are all driven from key underlying trends and phenomena that are being learned by the players 112. The particular variables that are manipulated are selected based on the specific subject matter of the simulation and the desired educational and training objectives, as would be readily appreciated by those of skill in the art relying upon the present description.

To facilitate the test starting knowledge at STEP 910 and at the start of a scenario, in an example, the player engagement tool 106 may present the player 112 with some entry questions. Digital coach 114, in an example, determines whether questions are asked and which questions are asked as a function of what questions have been asked and answered before and which economic factors were selected during scenario setup. In an example, player 112 in portfolio simulation initialization page 1002 selects a rising unemployment rate as their macroeconomic condition for the scenario. In order to prepare the player 112 for the rising unemployment rate scenario, in an example, the test starting knowledge STEP 910 will advise (or hint to) the player that in rising unemployment conditions are likely to result in an increased in the rate of flow of accounts from paid to current status into the 30 day delinquent status and this will have impacts on the number of accounts flowing in subsequent months to the more severe delinquency buckets. This will prepare the player 112 to review the delinquency flow rate data series in the present portfolio current conditions (new or vintage) at STEP 912 and increase a player's 112 ability to correctly analyze the presented data.

At STEP 912 of present portfolio current conditions (new or vintage), in an example, the player engagement tool 106 presents the current conditions of the portfolio. The player engagement tool 106, in an example, presents the current conditions of the portfolio at the start of a scenario and after each advancement of the portfolio simulation. While a particular challenge may focus on a specific KPI portfolio, in an example, the portfolio simulator 108 always generates all performance metrics that are saved in portfolio performance data tool 506. The portfolio performance data tool 506, in an example, are always available for review via either data server 202 or graph server 204. When a player 112, in an example, leaves a scenario before completing the scenario, when the player 112 returns to the game play, the player engagement tool 106 will start at present portfolio current conditions (new or vintage) at STEP 912.

In accordance with an example embodiment of the present invention, the player engagement tool 106, in an example, shows current portfolio conditions as reports in tabular form (as depicted in FIG. 12) and/or graphic form (as depicted in FIG. 13) spreadsheets and charts. For example, the tabular form, as depicted in FIG. 12, and the graphic form (e.g., sensitivity graph), as depicted in FIG. 13 can be presented as outputs from the player engagement tool 106 to the users (e.g., player 112 and administrator 212). The user interface logic 116 and the digital coach 114, in an example, serve and/or try to emphasize the use of chart data (as depicted in FIG. 13). For example, the sensitivity chart in FIG. 13 can be presented to the player 112 as a hint or context-specific coaching. Accordingly, the chart data, in an example, serves to promote and/or ease identification and/or recognition by the player 112 of inflection points in the graphical representation.

In accordance with an example embodiment of the present invention, when the player engagement tool 106 facilitates player inputs management decisions to the UI (inputs their decisions at STEP 914), in an example, the user interface logic 116 presents the player 112 with a set of controls. In particular, FIG. 19 illustrates in an example the player 112 can make the portfolio management decision of the credit score cutoff for the upcoming, simulated, period of time. Similarly, FIG. 21 illustrates the management decisions form 1202 in which the player can input their decisions via management decision selectors 1204. The user interface logic 116, in an example, includes color on input controls to reinforce the experience for the player 112, for example, red indicating a severe position and green indicating a lax position.

Continuing with FIG. 21, in accordance with an example embodiment of the present invention, the player engagement tool 106 allows the player 112 to return to the portfolio reports for review and reference at any time during the decision making process. Once the player 112 is happy and or satisfied with the set of decisions that the player 112 has set on the UI controls, in an example, the player 112 can select the continue button 1206. When the player 112 the selects the continue button 1206 in an example the decisions of the player 112 for that period are processed by the input processor 302 and saved to data storage 208. The player engagement tool 106, in an example, causes the account simulator 304 to advance the simulation (at STEP 916). In an example, the calculation engine 210 saves the player 112 input decisions and the performance data generated by analytics tool 306 to data storage 208.

At the advance portfolio simulation STEP 916, in an example, the player engagement tool 106 can advance the portfolio simulation in multiples of time increments, for example, monthly increments. For example, the player engagement tool 106 can advance the scenario play simulation in three month (quarterly) increments. STEP 916, in an example, serves to mirror the real data gathering and reporting cycles that would be found in a typical retail lending institution. In another example of a scenario, at STEP 916, the player engagement tool 106 advances simulations twelve months (one year) at a time.

In an example, the calculation engine 210 advances by one month. The calculation engine calls the data generated by the account simulator 304, using inputs from the admin engine 206 and from the administrator input from sensitivity curve form 802 (as depicted in FIG. 18), and the player inputs from portfolio simulation initialization page 1002 (as depicted in FIG. 19). In an example, the administrator 212 selected a rising unemployment condition in portfolio simulation initialization page 1002 which results in the calculation engine computing higher loan delinquency rates in analytics tool 306 which are presented to the player 112 in player engagement tool 106.

When the player engagement tool 106 interacts with the portfolio simulator 108, the player engagement tool 106, in an example, can only instruct the calculation engine 210 to advance one time increment, for example, one month, at a time. If an educational module 930 (or scenario), in an example, calls for a longer duration of elapsed time, the player engagement tool 106 must instruct the calculation engine 210 to advance one time increment, such as one month, as many times as the player engagement tool 106 needs. This feature enables the administrator 212 the flexibility to present time in elapsed durations which are suitable for the learning purposes of the particular educational module 930. In an example, the administrator 212 can craft an educational module 930 which advances one month at a time when presented to the player 112 in the player engagement tool 106 when the player 112, to achieve the learning objective, must analyze monthly transitions of account delinquency. In a contrasting example, the administrator 212 can craft an educational module 930 in which the calculation engine 210 calculates the results each monthly time increment but presents the results to the player in quarterly time increments in the player engagement tool 106. The administrator 212, in an example, would choose to present quarterly time increments when the player 112 should be analyzing longer term trends such as vintage delinquency which emerges over 12 to 36 month outcome periods. A full set of performance data, in an example, is generated at each monthly increment in portfolio performance data tool 506, which is available for review by the player 112 via the data server 202. The perception by the player 112 of quarterly or annual time elapsing, in an example, is therefore purely a function of player engagement tool 106 as the portfolio simulator 108 always advances one month at a time.

At scenario end STEP 918, in an example, after each advancement of the simulation, the player engagement tool 106 checks if the end of the scenario period has been reached. If the scenario is still ongoing, in an example, the digital coach 114 is invoked to review portfolio performance and player input which is available to the player in management decision form 1202. If the scenario period is complete, in an example, the player engagement tool 106 locks the portfolio simulation and the user input is saved in data storage 602 and portfolio performance data tool 506 can no longer be changed.

In accordance with the present invention, the in game coaching at STEP 920 the digital coach 114, in an example, is invoked for mid-play feedback. The digital coach 114 analyzes the inputs, performance, and scenario goals of the current scenario and may offer via the player engagement tool 106 more or less specific guidance or observations. Digital coach 114 identifies any lack of understanding on the part of the player 112, and provides just enough information for the player 112 to discover their errors or misunderstanding. If digital coach 114 provides too much detail, the learning effectiveness is reduced since the player 112 is no longer in a ‘discovery’ mode of learning. If digital coach 114 provides too little detail, the player will remain in a ‘failure’ mode without the knowledge to succeed in the game. In an example, the player 112, in the management decision form 1202 can select context specific coaching request 1208 which will present the context-specific in game coaching content (as depicted in FIG. 21). The algorithms in the calculation engine 210 are crafted to detect how successful the player 112 is based on the metrics such as the amount of cumulative net income, and the pattern of their decisions. In an example, if a player inputs certain combinations of decisions, the calculation will detect the player 112 is just guessing and will provide additional coaching content. If the calculation engine 210 detects that, with each trial run, the player decisions are slowly improving by increasing cumulative net income, decreasing delinquency, or improving other trends, the digital coach 114 may only provide a small hint and allow the player 112 to continue learning by doing. As would be appreciated by one skilled in the art, the hints provided in the data storage 208, 602 can be associated with different levels of obviousness for providing the final result (e.g., small to large hints).

In accordance with an example embodiment of the present invention, the digital coach 114, in an example, analyzes the set of decisions by the player 112 both in the current trial and previous trials in order to detect drivers or patterns of failure. Based on the identified patterns, context-specific content, in an example, is provided to the player 112 by digital coach 114 through player engagement tool 106.

In a further example, at the scenario end at STEP 918, once the player engagement tool 106 determines that a scenario is complete, the player engagement tool 106, in an example, progresses to present the final portfolio conditions of STEP 922 to the player 112. In an example, the administrator 212 employs the module management form 1102 to create the final scenario, which is generated by the calculation engine 210 and presented to the player 112 at the present the final portfolio conditions of STEP 922.

At the test ending knowledge STEP 924, in an example, analogously to test starting knowledge STEP 910 step, at the end of a scenario, the player engagement tool 106 may present the player 112 with some exit questions. The questions are asked and which questions are asked are a function of what questions have been asked and answered before and which economic factors were selected during scenario setup. The digital coach 114 determines which questions should be asked. The digital coach 114 employs algorithms which have inputs of: module topic, scenario choices of the administrator (in an example, economic stress setting), scenario choices by the player (in an example, selecting an aggressive score cutoff), and which questions were already asked of the player and if the answer was correct or not. In an example, the test starting knowledge STEP 910 asks the player 112 how a delinquency flow rate is calculated. During player engagement tool 106 the player 112 must correctly calculate the delinquency flow rate in order to have a successful game result. During in-game coaching, in an example, if the player did not answer the question correctly in the test starting knowledge STEP 910, an additional in-game coaching item will be presented to the player to reinforce the concept. At the test ending knowledge STEP 924 the digital coach 114 will ask the player to correctly calculate the delinquency flow rate.

At present, the endgame coaching insights STEP 926, in an example, the digital coach 114 is invoked by the player engagement tool 106 for end play feedback. The digital coach 114 analyzes the inputs, performance, and scenario goals of the current scenario and may determine a coaching approach that at the time offers more or less specific guidance or observations. The endgame coaching differs from the in-game coaching, in that the endgame coaching, in an example, summarizes the success and failures of the player 112 to ensure the player 112 understands what the player 112 has done correctly and incorrectly. Typically, but not always, if the player 112 succeeds, the player 112, in an example, knows why the player 112 succeeded. However, through this endgame-coaching step, user interface logic 116, in an example, ensures that the lesson is summarized and reinforced for the player 112. Each player 112 who succeeds in a particular level of difficulty of the game can then be assumed to possess the defined level of knowledge as characterized by the content of the endgame coaching. In an example, at present, the endgame coaching insights STEP 926, the digital coach 114 will advise the player 112 that they made mistakes in calculating and forecasting the delinquency flow rates in earlier trials, but mastered the knowledge in the final challenge. The digital coach reinforces and reminds the player 112 about this concept and how it helps them forecast the number of collectors required and forecast losses in their real job.

At STEP 932, once the player 112 has completed a scenario, in an example, the player engagement tool 106 returns to the player 112 to the player home page 708. At the player home page 708, the player 112, in an example, can review results of this and/or other previous scenarios and/or select to play another scenario. Additionally, at the player home page 708, the player 112 can choose to logout and exit from the user interface logic 116.

An implementation of the system 100 includes an algorithm, procedure, program, process, mechanism, engine, model, coordinator, module, unit, application, software, code, and/or logic. An implementation of the system 100 also includes one or more user-level programs, for example, user interface logic 116 residing in one or more user-level program files.

An implementation of the system 100 includes a plurality of components such as one or more of electronic components, chemical components, organic components, mechanical components, hardware components, optical components, and/or computer software components. A number of such components may be combined or divided in an implementation of the system 100. One or more components of an implementation of the system 100 and/or one or more parts thereof may include one or more of a computing, communication, interactive, and/or imaging device, interface, computer, and/or machine. One or more components of an implementation of the system 100 and/or one or more parts thereof may serve to allow selection, employment, channeling, processing, analysis, communication, and/or transformation of electrical signals and/or between and/or among physical, logical, transitional, transitory, persistent, and/or electrical signals, inputs, outputs, measurements, and/or representations.

A plurality of instances of a particular component may be present in an implementation of the system 100. One or more features described herein in connection with one or more components and/or one or more parts thereof may be applicable and/or extendible analogously to one or more other instances of the particular component and/or other components in an implementation of the system 100. One or more features described herein in connection with one or more components and/or one or more parts thereof may be omitted from or modified in one or more other instances of the particular component and/or other components in an implementation of the system 100. An exemplary technical effect is one or more exemplary and/or desirable functions, approaches, and/or procedures. An exemplary component of an implementation of the system 100 may employ and/or include a set and/or series of computer instructions written in or implemented with any of a number of programming languages, as will be appreciated by those skilled in the art.

An implementation of the system 100 may encompass an article and/or an article of manufacture. The article may comprise one or more computer-readable signal-bearing media. The article may include means and/or instructions in the one or more media for one or more exemplary and/or desirable functions, approaches, and/or procedures. The article may include computer instructions that, when executed by a processor, cause the processor to perform operations.

An implementation of the system 100 may employ one or more computer-readable signal-bearing media. A computer-readable signal-bearing medium may store software, firmware and/or assembly language for performing one or more portions of an implementation of the system 100. An example of a computer-readable signal bearing medium for an implementation of the system 100 may include a memory and/or recordable data storage medium of the memory 404, the data storage 208, and/or the data storage 602. A computer-readable signal-bearing medium for an implementation of the system 100 in an example may comprise a device and/or non-transitory recording medium into which data can be located for a length of time and subsequently retrieved. Data in an example may be one or more of located, placed, moved, and/or copied into a non-transitory recording medium as a computer-readable signal bearing medium for an implementation of the system 100. Data, in an example, may be one or more of located, stored, saved, and/or held until a later time in a non-transitory recording medium as a computer-readable signal bearing medium for an implementation of the system 100. Data, in an example, may be one or more of retrieved, accessed, obtained, restored, and/or reproduced from a non-transitory recording medium as a computer-readable signal bearing medium for an implementation of the system 100. For example, one or more portions and/or the entirety of the original data can be retrieved from a non-transitory recording medium of an implementation of the system 100. A computer-readable signal-bearing medium for an implementation of the system 100 in an example may comprise one or more of a magnetic, electrical, optical, biological, chemical, and/or atomic data storage medium. For example, an implementation of the computer-readable signal-bearing medium may comprise one or more flash drives, optical discs, memory cards, computer networks, CDs (compact discs), DVDs (digital video discs), hard drives, portable drives, and/or electronic memory. A computer-readable signal-bearing medium in an example may comprise a physical computer medium, computer-readable signal-bearing tangible medium, non-transitory medium, and/or non-transitory computer-readable tangible medium.

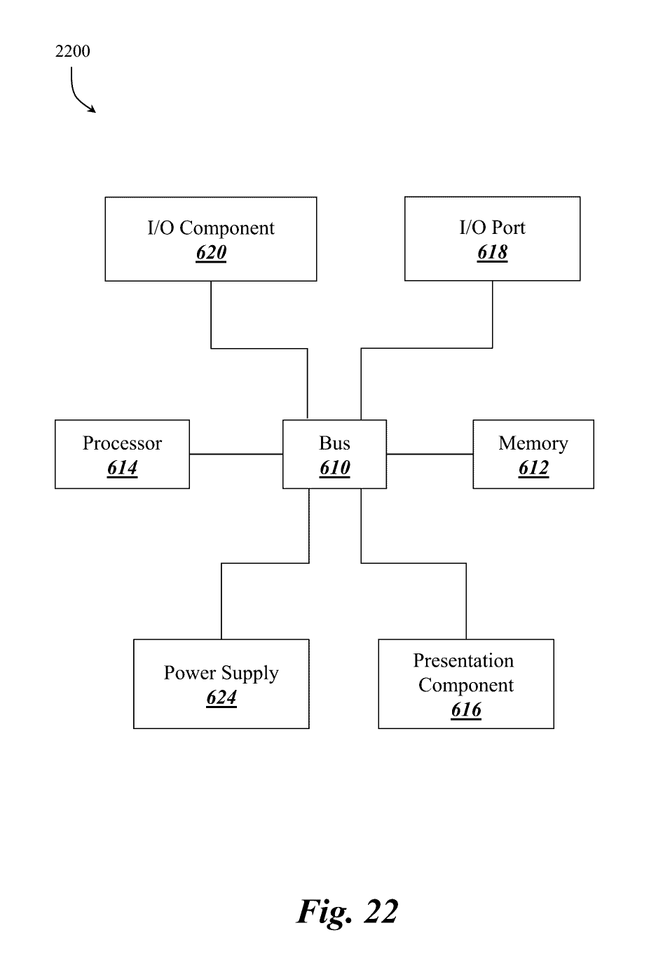

Any suitable computing device within the system 100 can be used to implement the computing devices 104 and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such computing device 104 is represented by computing device 600 depicted in FIG. 22. The computing device 600 is merely an illustrative example of a suitable computing environment and in no way limits the scope of the present invention. A “computing device,” as represented by FIG. 22, can include a “workstation,” a “server,” a “laptop,” a “desktop,” a “hand-held device,” a “mobile device,” a “tablet computer,” or other computing devices, as would be understood by those of skill in the art. Given that the computing device 600 is depicted for illustrative purposes, embodiments of the present invention may utilize any number of computing devices 600 in any number of different ways to implement a single embodiment of the present invention. Accordingly, embodiments of the present invention are not limited to a single computing device 600, as would be appreciated by one with skill in the art, nor are they limited to a single type of implementation or configuration of the example computing device 600.

The computing device 600 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 22 is merely illustrative of an exemplary computing device that can be used to implement one or more embodiments of the present invention, and in no way limits the invention.

The computing device 600 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 600.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 600 can include one or more processors that read data from components such as the memory 612, the various I/O components 616, etc. Presentation component(s) 616 present data indications to a user or other device. Exemplary presentation components include a display device, speaker, printing component, vibrating component, etc.

The I/O ports 618 can enable the computing device 600 to be logically coupled to other devices, such as I/O components 620. Some of the I/O components 620 can be built into the computing device 600. Examples of such I/O components 620 include a microphone, joystick, recording device, game pad, satellite dish, scanner, printer, wireless device, networking device, and the like.

The steps or operations described herein are examples. There may be variations to these steps or operations without departing from the spirit of the invention. For example, the steps may be performed in a differing order, or steps may be added, deleted, or modified.

Although exemplary implementation of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

The simulator of the present invention uses a new and innovative mechanism of portfolio simulation together with a new and innovative mechanism for digital coaching to more effectively train retail credit professionals to perform their related duties. This outcome saves time and money for the trainees' employers and, more importantly, reduces the risk of mismanagement of such portfolios damaging broad economies as it has in the past.

Specifically, the simulator of the present invention exposes players 11 to hundreds of years of portfolio management experience through the simulation. In real life, the lessons that could or should be learned from experience are often unclear. Using this system 100 the cause and effect of outcomes are not only very clear, they are reinforced and highlighted, when necessary, by the digital coach 114.

The simulator of the present invention provides a stylized reality using randomization and convolution. More specifically, the user interface logic 116 does not replicate a particular portfolio or case study of a historically observed reality. Instead, the user interface logic 116 creates a stylized and synthetically created reality for the player 112 which highlights and exaggerates key phenomena. For example, many cause and effect phenomena are non-linear in nature, so the stylized version ensures an exaggerated inflection point, ensuring the engaged player will notice the phenomena and learn it through repetitive play.

In order to allow players the opportunity for repetition and practice, the user interface logic uses bounded randomization and data convolution. The resulting system provides a repetitive and dynamic experience allowing the player to practice in many scenarios which vary in each trial, although the underlying phenomena are the same. The boundaries of the bounded randomization are set by the desired educational and training objectives. For example, defining a wider range of possible randomized values will result in more variability. In the specific implementation of lender portfolio simulation, this can be embodied by, e.g., introducing a more risky lending environment, more extreme customer behavior, variation on product offerings, or the like. Those of skill in the art will appreciate these are merely example variables and the present invention is by no means limited to these specific variables.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A simulator system, comprising:
a player engagement tool comprising:
a user interface logic provides a training simulation to a player on a client machine and receives one or more management decisions from the player during the training simulation;
a portfolio simulator data executes the training simulation and training material associated with the training simulation to be provided to the player;
wherein the training material is context specific information pertinent to management decisions the player is making during the training simulation with the user interface logic;
wherein the portfolio simulator updates the training simulation based on the one or more management decisions received by the user logic interface;
wherein the player engagement tool interacts with the player to provide the training simulation to the client machine of the player.

2. The system of claim 1, wherein the user interface logic responds to a request from the client machine for the training simulation.

3. The system of claim 2, wherein the providing the training simulation comprises rendering a training home page to the player on the client machine.

4. The system of claim 1, wherein the training material explains an underlying phenomena of customer and portfolio behavior to assist the player in understanding a cause and an effect of the one or more management decisions.

5. The system of claim 1, wherein the user interface logic validates an input provided within the one or more management decisions, the validating comprising determining whether the one or more management decisions provided by the player match expected responses for the provided training simulation options.

6. The system of claim 1, wherein the portfolio simulator provides feedback and reports to the player for use during the training simulation including prior to the player submitting one or more management decisions and after receiving the one or more management decisions from the player.

7. The system of claim 6, wherein the portfolio simulator evaluates the one or more decisions from the player to determine whether the one or more decisions are technically possible but out-of-policy.

8. The system of claim 1, wherein the portfolio simulator provides reports and tabular data to the player that reflect an impact the one or more management decisions had on the training simulation.

9. The system of claim 1, the player engagement tool further comprising a digital coach configured to provide educational material to the player based on management decisions received from the player.

10. The system of claim 9, wherein the educational material provides information to teach the player lessons to improve upon the one or more management decisions.

11. A simulator system, comprising:
a portfolio simulator employing a stylized statistical simulation comprising:
a macroeconomic data tool providing a selection of a baseline sensitivity curve, the baseline sensitivity curve representative of a stylized trend including key variables;
a calculation engine generating a plurality of simulation accounts;
an account simulator generating data for populating the plurality of simulation accounts using a random number generator; and
the calculation engine creating the stylized statistical simulation by creating a simulated reality using the plurality of simulation accounts that highlight and exaggerate key variables of the stylized trend, the key variables being limited to a predetermined standard deviation from a historical norm; and
the portfolio simulator providing the simplified and stylized statistical simulation to a player.

12. The system of claim 11, wherein the portfolio simulator is a state machine

13. The system of claim 12, wherein the state machine is maintained based upon the impact of one or more management decisions received from the player to a previous state of the state machine.

14. The system of claim 11, wherein the portfolio simulator provides the simplified and stylized statistical simulation to a player including user inputs for one or more data management decisions.

15. The system of claim 14, wherein the portfolio simulator receives the one or more data management decisions from the player and updates the simplified and stylized statistical simulation based on the one or more data management decisions.

16. The system of claim 11, wherein the portfolio simulator receives a simulation call from a user interface logic for a selected training module.

17. The system of claim 16, wherein in response to receiving the simulation call, the portfolio simulator provides the simplified and stylized statistical simulation for the selected training module.

18. A simulator method, comprising:
a portfolio simulator providing a plurality of training scenarios to a user;
a player engagement tool receiving management decisions from the user in response to the plurality of training scenarios;
a discovery learning mode determining a result of the received management decisions;
when determining the result is an incorrect management decision, the discovery learning mode identifies a strategy of the user causing the incorrect management decision and determines a corrective action, the corrective action comprising a context-specific hint;
a digital coach providing the context-specific hint to the user;
the player engagement tool receiving new management decisions from the user; and
wherein the user is provided with additional context-specific hints without providing a correct management decisions until the user submits the correct management decisions.

19. The method of claim 18, wherein the portfolio simulator receives a simulation call from a user interface logic for a selected training scenario of the plurality of training scenarios.

20. The method of claim 19, wherein in response to receiving the simulation call, the portfolio simulator outputs the simplified and stylized statistical simulation for the selected training scenarios.
